(19) United States
(12) Patent Application Publication
(10) Pub. No.: US 2025/0374307 A1
(43) Pub. Date: Dec. 4, 2025

(54) USER EQUIPMENTS, BASE STATIONS, AND COMMUNICATION METHODS

(71) Applicant: SHARP KABUSHIKI KAISHA, Sakai City, Osaka (JP)

(72) Inventors: LIQING LIU, Sakai City, Osaka (JP); DAIICHIRO NAKASHIMA, Sakai City, Osaka (JP); WATARU OUCHI, Sakai City, Osaka (JP); SHOICHI SUZUKI, Sakai City, Osaka (JP); Ryunosuke SAKAMOTO, Sakai City, Osaka (JP)

(21) Appl. No.: 18/876,744

(22) PCT Filed: Jun. 30, 2023
(86) PCT No.: PCT/JP2023/025211

§ 371 Date: Dec. 19, 2024

(30) Foreign Application Priority Data
Jul. 5, 2022 (JP) 2022-108183

(51) Int. Cl. H04W 72/40; H04L 27/26; H04W 72/0453; H04W 72/0457; H04W 72/25

(52) U.S. Cl. CPC H04W 72/40; H04L 27/26025; H04W 72/0453; H04W 72/0457; H04W 72/25

(57) ABSTRACT

A method by a user equipment (UE) is described. The method includes receiving a sidelink (SL) resource pool configuration included in a pre-configuration or from a base station, the SL resource pool configuration indicating a SL resource pool in a SL bandwidth part (BWP), the SL resource pool including a first number of one or more RB sets; and control unit configured to determine a second number of one or more sub-channels at least based on a third number of interlaces and a first parameter, the first parameter indicating a fourth number of interlaces to be included in a sub-channel, and to determine a size of a frequency resource assignment field in a SCI format as (X+Y) bits, X bits providing sub-channel allocation, Y bits providing RB set allocation, wherein a value of the X is determined based on the determined second number, a value of the Y is determined based on the first number.

### TECHNICAL FIELD

The present disclosure relates to a user equipment, a base station, and a communication method.

### BACKGROUND ART

At present, as a radio access system and a radio network technology aimed for the fifth generation cellular system, technical investigation and standard development are being conducted, as extended standards of Long Term Evolution (LTE), on LTE-Advanced Pro (LTE-A Pro) and New Radio technology (NR) in The Third Generation Partnership Project (3GPP).

In the fifth generation cellular system, three services of enhanced Mobile BroadBand (eMBB) to achieve high-speed and large-volume transmission, Ultra-Reliable and Low Latency Communication (URLLC) to achieve low-latency and high-reliability communication, and massive Machine Type Communication (mMTC) to allow connection of a large number of machine type devices such as Internet of Things (IoT) have been demanded as assumed scenarios.

For example, wireless communication devices may communicate with one or more device. For sidelink communication, two communication devices can communicate with each other via PC-5 interface. However, given the existing sidelink communication methods can not directly applied to unlicensed spectrum, the flexibility and/or the efficiency of the whole sidelink communication system would be limited. As illustrated by this discussion, systems and methods according to the present invention, supporting sidelink communication over unlicensed spectrum, which may improve the communication flexibility and/or efficiency, would be beneficial.

### BRIEF DESCRIPTION OF THE DRAWINGS

FIG. 1 is a block diagram illustrating one configuration of one or more base stations and one or more user equipments (UEs) in which systems and methods for determination of the size of frequency resource assignment field may be implemented;

FIG. 2 is a diagram illustrating one example 200 of a resource grid;

FIG. 3 is a diagram illustrating one example 300 of common resource block grid, carrier configuration and BWP configuration by a UE 102 and a base station 160;

FIG. 4 is a diagram illustrating one 400 example of CORESET configuration in a BWP by a UE 102 and a base station 160;

FIG. 5 is a diagram illustrating one example 500 for interlaced resource blocks for transmission and reception;

FIG. 6 is a diagram illustrating one example 600 of interlaced mapping for a BWP;

FIG. 7 is a diagram illustrating one example 700 of a SL BWP and a resource pool within the SL BWP;

FIG. 8 is a diagram illustrating one example 800 of a resource pool configuration;

FIG. 9 is a diagram illustrating one example 900 of configurations of a SL BWP and SL resource pools;

FIG. 10 is a flow diagram illustrating one implementation of a method 1000 for determination of frequency resource assignment field by a UE 102;

FIG. 11 illustrates various components that may be utilized in a UE;

FIG. 12 illustrates various components that may be utilized in a base station;

### DESCRIPTION OF EMBODIMENTS

A user equipment (UE) is described. The UE includes reception circuitry configured to receive a sidelink (SL) resource pool configuration included in a pre-configuration or from a base station, the SL resource pool configuration indicating a SL resource pool in a SL bandwidth part (BWP); and control unit configured to determine a number of one or more sub-channels included in the SL resource pool at least based on a number of interlace M, a first parameter wherein the first parameter indicates a number of interlaces to be included in a sub-channel in the resource pool, to determine a size of a frequency resource assignment field in a SCI format based on the determined number of the one or more sub-channels wherein the frequency resource assignment field is used to allocate frequency domain resource for PSSCH transmission in the SL resource pool in the SL BWP.

A communication method by a user equipment (UE) is described. The method includes receiving a sidelink (SL) resource pool configuration included in a pre-configuration or from a base station, the SL resource pool configuration indicating a SL resource pool in a SL bandwidth part (BWP); determining a number of one or more sub-channels included in the SL resource pool at least based on a number of interlace M, a first parameter wherein the first parameter indicates a number of interlaces to be included in a sub-channel; and determining a size of a frequency resource assignment field in a SCI format based on the determined number of the one or more sub-channels wherein the frequency resource assignment field is used to allocate frequency domain resource for PSSCH transmission in the SL resource pool in the SL BWP.

A base station is described. The base station includes transmission circuitry configured to transmit, to a user equipment (UE), a sidelink (SL) resource pool configuration indicating a SL resource pool in a SL bandwidth part (BWP); and control unit configured to determine a number of one or more sub-channels included in the SL resource pool at least based on a number of interlace M, a first parameter wherein the first parameter indicates a number of interlaces to be included in a sub-channel in the resource pool, to determine a size of a frequency resource assignment field in a downlink control information (DCI) format based on the determined number of the one or more sub-channels wherein the frequency resource assignment field is used to allocate frequency domain resource for PSSCH transmission in the SL resource pool in the SL BWP.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN). 3GPP NR (New Radio) is the name given to a project to improve the LTE mobile phone or device standard to cope with future requirements. In one aspect, LTE has been modified to provide support and specification (TS 38.331, 38.321, 38.300, 37.340, 38.211, 38.212, 38.213, 38.214, etc.) for the New Radio Access (NR) and Next generation-Radio Access Network (NG-RAN).

At least some aspects of the systems and methods disclosed herein may be described in relation to the 3GPP LTE, LTE-Advanced (LTE-A), LTE-Advanced Pro, New Radio Access (NR), and other 3G/4G/5G standards (e.g., 3GPP Releases 8, 9, 10, 11, 12, 13, 14, 15, 16, and/or 17, and/or Narrow Band-Internet of Things (NB-IoT)). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE (User Equipment), an access terminal, a subscriber station, a mobile terminal, a remote station, a user terminal, a terminal, a subscriber unit, a mobile device, a relay node, etc. Examples of wireless communication devices include cellular phones, smart phones, personal digital assistants (PDAs), laptop computers, netbooks, e-readers, wireless modems, industrial wireless sensors, video surveillance, wearables, vehicles, roadside units, infrastructure devices, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.”

In 3GPP specifications, a base station is typically referred to as a gNB, a Node B, an eNB, a home enhanced or evolved Node B (HeNB) or some other similar terminology. As the scope of the disclosure should not be limited to 3GPP standards, the terms “base station,”, “gNB”, “Node B,” “eNB,” and “HeNB” may be used interchangeably herein to mean the more general term “base station.” Furthermore, one example of a “base station” is an access point. An access point may be an electronic device that provides access to a network (e.g., Local Area Network (LAN), the Internet, etc.) for wireless communication devices. The term “communication device” may be used to denote both a wireless communication device and/or a base station.

It should be noted that as used herein, a “cell” may be any communication channel that is specified by standardization or regulatory bodies to be used for International Mobile Telecommunications-Advanced (IMT-Advanced), IMT-2020 (5G) and all of it or a subset of it may be adopted by 3GPP as licensed bands (e.g., frequency bands) to be used for communication between a base station and a UE. It should also be noted that in NR, NG-RAN, E-UTRA and E-UTRAN overall description, as used herein, a “cell” may be defined as “combination of downlink and optionally uplink resources.” The linking between the carrier frequency of the downlink resources and the carrier frequency of the uplink resources may be indicated in the system information transmitted on the downlink resources.

“Configured cells” are those cells of which the UE is aware and is allowed by a base station to transmit or receive information. “Configured cell(s)” may be serving cell(s). The UE may receive system information and perform the required measurements on configured cells. “Configured cell(s)” for a radio connection may consist of a primary cell and/or no, one, or more secondary cell(s). “Activated cells” are those configured cells on which the UE is transmitting and receiving. That is, activated cells are those cells for which the UE monitors the physical downlink control channel (PDCCH) and in the case of a downlink transmission, those cells for which the UE decodes a physical downlink shared channel (PDSCH). “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics.

The base stations may be connected by the NG interface to the 5G-core network (5G-CN). 5G-CN may be called as to NextGen core (NGC), or 5G core (5GC). The base stations may also be connected by the S1 interface to the evolved packet core (EPC). For instance, the base stations may be connected to a NextGen (NG) mobility management function by the NG-2 interface and to the NG core User Plane (UP) functions by the NG-3 interface. The NG interface supports a many-to-many relation between NG mobility management functions, NG core UP functions and the base stations. The NG-2 interface is the NG interface for the control plane and the NG-3 interface is the NG interface for the user plane. For instance, for EPC connection, the base stations may be connected to a mobility management entity (MME) by the S1-MME interface and to the serving gateway (S-GW) by the S1-U interface. The S1 interface supports a many-to-many relation between MMEs, serving gateways and the base stations. The S1-MME interface is the S1 interface for the control plane and the S1-U interface is the S1 interface for the user plane. The Uu interface is a radio interface between the UE and the base station for the radio protocol.

The radio protocol architecture may include the user plane and the control plane. The user plane protocol stack may include packet data convergence protocol (PDCP), radio link control (RLC), medium access control (MAC) and physical (PHY) layers. A DRB (Data Radio Bearer) is a radio bearer that carries user data (as opposed to control plane signaling). For example, a DRB may be mapped to the user plane protocol stack. The PDCP, RLC, MAC and PHY sublayers (terminated at the base station 460a on the network) may perform functions (e.g., header compression, ciphering, scheduling, ARQ and HARQ) for the user plane. PDCP entities are located in the PDCP sublayer. RLC entities may be located in the RLC sublayer. MAC entities may be located in the MAC sublayer. The PHY entities may be located in the PHY sublayer.

The control plane may include a control plane protocol stack. The PDCP sublayer (terminated in base station on the network side) may perform functions (e.g., ciphering and integrity protection) for the control plane. The RLC and MAC sublayers (terminated in base station on the network side) may perform the same functions as for the user plane. The Radio Resource Control (RRC) (terminated in base station on the network side) may perform the following functions. The RRC may perform broadcast functions, paging, RRC connection management, radio bearer (RB) control, mobility functions, UE measurement reporting and control. The Non-Access Stratum (NAS) control protocol (terminated in MME on the network side) may perform, among other things, evolved packet system (EPS) bearer management, authentication, evolved packet system connection management (ECM)-IDLE mobility handling, paging origination in ECM-IDLE and security control.

Signaling Radio Bearers (SRBs) are Radio Bearers (RB) that may be used only for the transmission of RRC and NAS messages. Three SRBs may be defined. SRB0 may be used for RRC messages using the common control channel (CCCH) logical channel. SRB1 may be used for RRC messages (which may include a piggybacked NAS message) as well as for NAS messages prior to the establishment of SRB2, all using the dedicated control channel (DCCH) logical channel. SRB2 may be used for RRC messages which include logged measurement information as well as for NAS messages, all using the DCCH logical channel. SRB2 has a lower-priority than SRB1 and may be configured by a network (e.g., base station) after security activation. A broadcast control channel (BCCH) logical channel may be used for broadcasting system information. Some of BCCH logical channel may convey system information which may be sent from the network to the UE via BCH (Broadcast Channel) transport channel. BCH may be sent on a physical broadcast channel (PBCH). Some of BCCH logical channel may convey system information which may be sent from the network to the UE via DL-SCH (Downlink Shared Channel) transport channel. Paging may be provided by using paging control channel (PCCH) logical channel.

System information may be divided into the MasterInformationBlock (MIB) and a number of SystemInformationBlocks (SIBs).

The UE may receive one or more RRC messages from the base station to obtain RRC configurations or parameters. The RRC layer of the UE may configure RRC layer and/or lower layers (e.g., PHY layer, MAC layer, RLC layer, PDCP layer) of the UE according to the RRC configurations or parameters which may be configured by the RRC messages, broadcasted system information, and so on. The base station may transmit one or more RRC messages to the UE to cause the UE to configure RRC layer and/or lower layers of the UE according to the RRC configurations or parameters which may be configured by the RRC messages, broadcasted system information, and so on.

The size of various fields in the time domain is expressed in time units T_{c}=1/(Δfₘₐₓ×N_{f}) where Δfₘₐₓ=480×10³ Hz and N_{f}=4096. The constant κ=Tₛ/T_{c}=64 where Tₛ=1/(Δf_{ref}·N_{f,ref}), Δf_{ref}=15·10³ Hz and N_{f,ref}=2048.

Multiple OFDM numerologies are supported as given by Table 4.2-1 of [TS 38.211] where μ and the cyclic prefix for a bandwidth part are obtained from the higher-layer parameter subcarrierSpacing and cyclicPrefix, respectively.

The size of various fields in the time domain may be expressed as a number of time units T_{c}=1/(15000×2048) seconds. Downlink and uplink transmissions are organized into frames with T_{f}=(ΔfₘₐₓN_{f}/100)·T_{c}=10 ms duration, each consisting of ten subframes of T_{sf}=(ΔfₘₐₓN_{f}/1000)·T_{c}=1 ms duration. The number of consecutive OFDM symbols per subframe is

$${N}_{s y m b}^{subframe , μ} = {N}_{s y m b}^{s l o t} {N}_{slot}^{subframe , μ} .$$

frames of five subframes each with half-frame 0 consisting of subframes 0-4 and half-frame 1 consisting of subframes 5-9.

For subcarrier spacing (SCS) configuration μ, slots are numbered

$${n}_{s}^{μ} ∈ \{ 0 , ... , {N}_{slot}^{subframe , μ} - 1 \}$$

in increasing order within a subframe and

$${n}_{s , f}^{μ} ∈ \{ 0 , ... , {N}_{slot}^{frame , μ} - 1 \}$$

in increasing order within a frame.

$${N}_{slot}^{subframe , μ}$$

is the number of slots per subframe for subcarrier spacing configuration μ. There are

$${N}_{symb}^{slot}$$

consecutive OFDM symbols in a slot where

$${N}_{symb}^{slot}$$

depends on the cyclic prefix as given by Tables 4.3.2-1 and 4.3.2-2 of [TS 38.211]. The start of slot

$${n}_{s}^{μ}$$

in a subframe is aligned in time with the start of OFDM symbol

$${n}_{s}^{μ} {N}_{symb}^{slot}$$

in the same subframe. Subcarrier spacing refers to a spacing (or frequency bandwidth) between two consecutive subcarriers in the frequency domain. For example, the subcarrier spacing can be set to 15 kHz (i.e. μ=0), 30 kHz (i.e. μ=1), 60 kHz (i.e. μ=2), 120 kHz (i.e. μ=3), or 240 kHz (i.e. μ=4). A resource block is defined as a number of consecutive subcarriers (e.g. 12) in the frequency domain. For a carrier with different frequency, the applicable subcarrier may be different. For example, for a carrier in a frequency rang 1, a subcarrier spacing only among a set of {15 kHz, 30 kHz, 60 kHz} is applicable. For a carrier in a frequency rang 2, a subcarrier spacing only among a set of {60 kHz, 120 kHz, 240 kHz} is applicable. The base station may not configure an inapplicable subcarrier spacing for a carrier.

OFDM symbols in a slot can be classified as ‘downlink’, ‘flexible’, or ‘uplink’. Signaling of slot formats is described in subclause 11.1 of [TS 38.213].

In a slot in a downlink frame, the UE may assume that downlink transmissions only occur in ‘downlink’ or ‘flexible’ symbols. In a slot in an uplink frame, the UE may only transmit in ‘uplink’ or ‘flexible’ symbols.

Various examples of the systems and methods disclosed herein are now described with reference to the Figures, where like reference numbers may indicate functionally similar elements. The systems and methods as generally described and illustrated in the Figures herein could be arranged and designed in a wide variety of different implementations. Thus, the following more detailed description of several implementations, as represented in the Figures, is not intended to limit scope, as claimed, but is merely representative of the systems and methods.

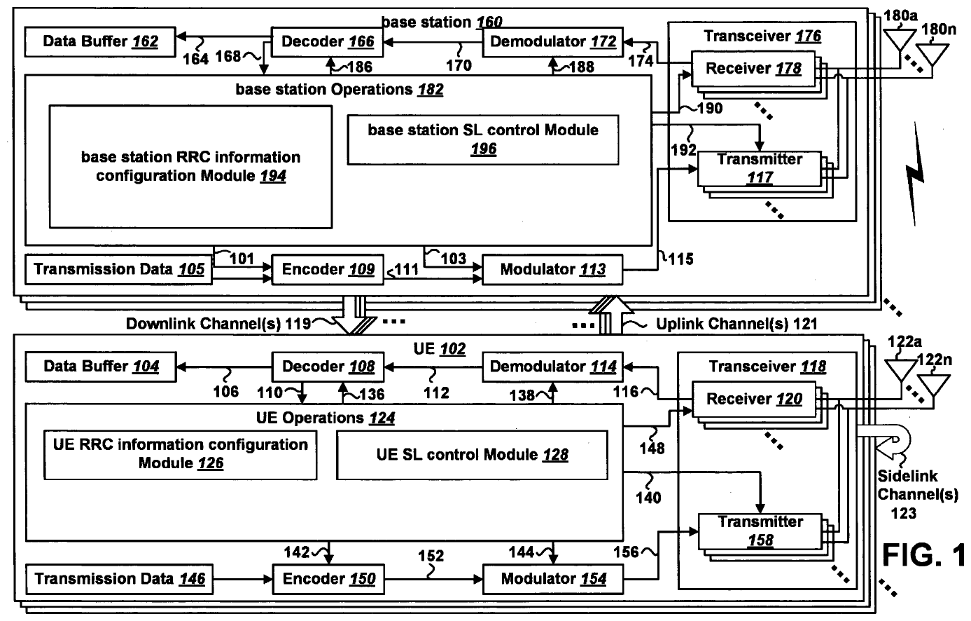

FIG. 1 is a block diagram illustrating one configuration of one or more base stations 160 (e.g., eNB, gNB) and one or more user equipments (UEs) 102 in which systems and methods for determination of the size of frequency resource assignment may be implemented. The one or more UEs 102 may communicate with one or more base stations 160 using one or more antennas 122a-n. For example, a UE 102 transmits electromagnetic signals to the base station 160 and receives electromagnetic signals from the base station 160 using the one or more antennas 122a-n. The base station 160 communicates with the UE 102 using one or more antennas 180a-n. Additionally, one or more UEs 102 may communicate with one or more UEs 102 using one or more antennas 122a-n. For example, a UE 102 transmits electromagnetic signals to another UE(s) 102 and receives electromagnetic signals from another UE(s) 102 using the one or more antennas 122a-n. That is, one or more UEs communicate with each other via sidelink communication.

The UEs 102 may directly communicate with each other by using the sidelink communication. For illustration, UE(s) 102 capable of sidelink communication include a UE 1A, a UE 1B and a UE 1C. The UE 1A may be located within the coverage of the base station 160. The UE 1B and the UE 1C may be located outside the coverage of the base station 160. The UE 1A and the base station 160 may communicate with each other via downlink and uplink communication. In addition, the UE 1A and the UE 1B may directly communicate with each other via sidelink communication. In addition, the UE 1B and the UE 1C may directly communicate with each other via sidelink communication.

It should be noted that in some configurations, one or more of the UEs 102 described herein may be implemented in a single device. For example, multiple UEs 102 may be combined into a single device in some implementations. Additionally or alternatively, in some configurations, one or more of the base stations 160 described herein may be implemented in a single device. For example, multiple base stations 160 may be combined into a single device in some implementations. In the context of FIG. 1, for instance, a single device may include one or more UEs 102 in accordance with the systems and methods described herein. Additionally or alternatively, one or more base stations 160 in accordance with the systems and methods described herein may be implemented as a single device or multiple devices.

The UE 102 and the base station 160 may use one or more channels 119, 121 to communicate with each other. For example, a UE 102 may transmit information or data to the base station 160 using one or more uplink (UL) channels 121 and signals. Examples of uplink channels 121 include a physical uplink control channel (PUCCH) and a physical uplink shared channel (PUSCH), etc. Examples of uplink signals include a demodulation reference signal (DMRS) and a sounding reference signal (SRS), etc. The one or more base stations 160 may also transmit information or data to the one or more UEs 102 using one or more downlink (DL) channels 119 and signals, for instance. Examples of downlink channels 119 include a PDCCH, a PDSCH, etc. A PDCCH can be used to schedule DL transmissions on PDSCH and UL transmissions on PUSCH, where the Downlink Control Information (DCI) on PDCCH includes downlink assignment and uplink scheduling grants. A PDCCH can be also used for scheduling of sidelink transmissions on PSCCH and PSSCH in one cell, where the Downlink Control Information (DCI) on PDCCH includes sidelink scheduling grants. The PDCCH is used for transmitting Downlink Control Information (DCI) in a case of downlink radio communication (radio communication from the base station to the UE). Here, one or more DCIs (may be referred to as DCI formats) are defined for transmission of downlink control information. Information bits are mapped to one or more fields defined in a DCI format. Examples of downlink signals include a primary synchronization signal (PSS), a secondary synchronization signal (SSS), a cell-specific reference signal (CRS), a non-zero power channel state information reference signal (NZP CSI-RS), and a zero power channel state information reference signal (ZP CSI-RS), etc. Other kinds of channels or signals may be used.

For the UE(s) 102 capable of sidelink communication, the UEs 102 may use one or more sidelink channels 123 to communicate with each other. For example, a UE 102 may transmit information or data to another UE 102 using one or more sidelink (SL) channels 123 and signals. Examples of sidelink channels 123 include a physical sidelink control channel (PSCCH), a physical sidelink shared channel (PSSCH), a physical sidelink feedback channel (PSFCH), and a physical sidelink broadcast channel (PSBCH). Examples of sidelink signals include a demodulation reference signal (DMRS), a phase-tracking reference signal (PT-RS), a channel-state information reference signal (CSI-RS), a sidelink primary synchronization signal (S-PSS), and a sidelink secondary synchronization signal (S-SSS).

Each of the one or more UEs 102 may include one or more transceivers 118, one or more demodulators 114, one or more decoders 108, one or more encoders 150, one or more modulators 154, one or more data buffers 104 and one or more UE operations modules 124. For example, one or more reception and/or transmission paths may be implemented in the UE 102. For convenience, only a single transceiver 118, decoder 108, demodulator 114, encoder 150 and modulator 154 are illustrated in the UE 102, though multiple parallel elements (e.g., transceivers 118, decoders 108, demodulators 114, encoders 150 and modulators 154) may be implemented.

The transceiver 118 may include one or more receivers 120 and one or more transmitters 158. The one or more receivers 120 may receive signals (e.g., downlink channels, downlink signals, sidelink channels, sidelink signals) from the base station 160 or from another UE 102 using one or more antennas 122a-n. For example, the receiver 120 may receive and downconvert signals to produce one or more received signals 116. The one or more received signals 116 may be provided to a demodulator 114. The one or more transmitters 158 may transmit signals (e.g., uplink channels, uplink signals, sidelink channels, sidelink signals) to the base station 160 or to another UE 102 using one or more antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce one or more decoded signals 106, 110. For example, a first UE-decoded signal 106 may comprise received payload data, which may be stored in a data buffer 104. A second UE-decoded signal 110 may comprise overhead data and/or control data. For example, the second UE-decoded signal 110 may provide data that may be used by the UE operations module 124 to perform one or more operations.

As used herein, the term “module” may mean that a particular element or component may be implemented in hardware, software or a combination of hardware and software. However, it should be noted that any element denoted as a “module” herein may alternatively be implemented in hardware. For example, the UE operations module 124 may be implemented in hardware, software or a combination of both.

In general, the UE operations module 124 may enable the UE 102 to communicate with the one or more base stations 160. For a UE capable of sidelink communication, the UE operations module 124 may enable the UE 102 to communicate with the one or more other UE. The UE operations module 124 may include a UE RRC information configuration module 126. For a UE capable of sidelink communication, the UE operations module 124 may include a UE sidelink (SL) control module 128. In some implementations, the UE operations module 124 may include physical (PHY) entities, Medium Access Control (MAC) entities, Radio Link Control (RLC) entities, packet data convergence protocol (PDCP) entities, and a Radio Resource Control (RRC) entity. For example, the UE RRC information configuration module 126 may process RRC parameter for random access configurations, initial UL BWP configuration, maximum bandwidth the UE can support, and cell specific PUCCH resource configuration(s).

For a UE capable of sidelink transmission, the UE RRC information configuration module 126 may process parameters included in the (pre-)configuration(s) related to sidelink communications. The UE RRC information configuration module 126 may include a memory unit to store the (pre-)configuration(s) related to sidelink communications. For example, the UE RRC information configuration module 126 may, based on the parameters, determine a SL BWPs, one or more resource pools within the SL BWP in frequency domain and time domain for SL communications. The UE SL control module 128 may determine the frequency resources and the time resources for transmission or reception of the PSCCH, the PSSCH and the PSFCH. The frequency resources for transmission or reception of the PSCCH, the PSSCH and the PSFCH include information related to assigned interlace(s) and RB set(s).

The UE RRC information configuration module 126 may or may not provide a third parameter to the UE SL control module 128 according to whether the SL resource pool configuration includes the third parameter or not. The UE SL control module 128 may determine a size of a frequency resource assignment included in a SCI format 1-A based on whether the SL resource pool configuration includes the third parameter or not. The third parameter is used to indicate that the resource pool is applied with interlaced transmission or not.

The UE SL control module 128 may determine sub-channels over the unlicensed spectrum. The UE SL control module (processing module) 128 may determine which one or more interlaces of M interlaces are included in a sub-channel based on a first parameter and a second parameter. The first parameter indicates an RB index with respect to a lowest RB index of the SL BWP and the second parameter indicates a number of interlaces, K, included in a sub-channel in a resource pool.

The UE operations module 124 may provide information 148 to the one or more receivers 120. For example, the UE operations module 124 may inform the receiver(s) 120 when or when not to receive transmissions based on the Radio Resource Control (RRC) message (e.g., broadcasted system information, RRC reconfiguration message), MAC control element, SCI (Sidelink Control Information) and/or the DCI (Downlink Control Information). The UE operations module 124 may provide information 148, including the PDCCH monitoring occasions, DCI format size, PSCCH monitoring occasions and SCI format size, to the one or more receivers 120. The UE operation module 124 may inform the receiver(s) 120 when or where to receive/monitor the PDCCH candidate for DCI formats and/or the PSCCH candidate for SCI formats.

The UE operations module 124 may provide information 138 to the demodulator 114. For example, the UE operations module 124 may inform the demodulator 114 of a modulation pattern anticipated for transmissions from the base station 160.

The UE operations module 124 may provide information 136 to the decoder 108. For example, the UE operations module 124 may inform the decoder 108 of an anticipated encoding for transmissions from the base station 160. For example, the UE operations module 124 may inform the decoder 108 of an anticipated PDCCH candidate encoding with which DCI size for transmissions from the base station 160. The UE operations module 124 may inform the decoder 108 of an anticipated PSCCH candidate encoding with which SCI size for transmissions from another UE 102.

The UE operations module 124 may provide information 142 to the encoder 150. The information 142 may include data to be encoded and/or instructions for encoding. For example, the UE operations module 124 may instruct the encoder 150 to encode transmission data 146 and/or other information 142.

The encoder 150 may encode transmission data 146 and/or other information 142 provided by the UE operations module 124. For example, encoding the data 146 and/or other information 142 may involve error detection and/or correction coding, mapping data to space, time and/or frequency resources for transmission, multiplexing, etc. The encoder 150 may provide encoded data 152 to the modulator 154.

The UE operations module 124 may provide information 144 to the modulator 154. For example, the UE operations module 124 may inform the modulator 154 of a modulation type (e.g., constellation mapping) to be used for transmissions to the base station 160. The modulator 154 may modulate the encoded data 152 to provide one or more modulated signals 156 to the one or more transmitters 158.

The UE operations module 124 may provide information 140 to the one or more transmitters 158. This information 140 may include instructions for the one or more transmitters 158. For example, the UE operations module 124 may instruct the one or more transmitters 158 when to transmit a signal to the base station 160 or another UE 102. The one or more transmitters 158 may upconvert and transmit the modulated signal(s) 156 to one or more base stations 160 or another one or more UEs 102.

The base station 160 may include one or more transceivers 176, one or more demodulators 172, one or more decoders 166, one or more encoders 109, one or more modulators 113, one or more data buffers 162 and one or more base station operations modules 182. For example, one or more reception and/or transmission paths may be implemented in a base station 160. For convenience, only a single transceiver 176, decoder 166, demodulator 172, encoder 109 and modulator 113 are illustrated in the base station 160, though multiple parallel elements (e.g., transceivers 176, decoders 166, demodulators 172, encoders 109 and modulators 113) may be implemented.

The transceiver 176 may include one or more receivers 178 and one or more transmitters 117. The one or more receivers 178 may receive signals (e.g., uplink channels, uplink signals) from the UE 102 using one or more antennas 180a-n. For example, the receiver 178 may receive and downconvert signals to produce one or more received signals 174. The one or more received signals 174 may be provided to a demodulator 172. The one or more transmitters 117 may transmit signals (e.g., downlink channels, downlink signals) to the UE 102 using one or more antennas 180a-n. For example, the one or more transmitters 117 may upconvert and transmit one or more modulated signals 115.

The demodulator 172 may demodulate the one or more received signals 174 to produce one or more demodulated signals 170. The one or more demodulated signals 170 may be provided to the decoder 166. The base station 160 may use the decoder 166 to decode signals. The decoder 166 may produce one or more decoded signals 164, 168. For example, a first base station-decoded signal 164 may comprise received payload data, which may be stored in a data buffer 162. A second base station-decoded signal 168 may comprise overhead data and/or control data. For example, the second base station-decoded signal 168 may provide data (e.g., PUSCH transmission data) that may be used by the base station operations module 182 to perform one or more operations.

In general, the base station operations module 182 may enable the base station 160 to communicate with the one or more UEs 102. For a base station capable of sidelink communication, the UE operations module 124 may enable the base station 160 to communicate with the one or more UEs 102 capable of sidelink communication. The base station operations module 182 may include a base station RRC information configuration module 194. For a base station capable of sidelink communication, the base station operations module 182 may include a base station sidelink (SL) control module 196 (or a base station SL processing module 196). The base station operations module 182 may include PHY entities, MAC entities, RLC entities, PDCP entities, and an RRC entity.

For a base station capable of sidelink transmission, the base station SL control module 196 may determine, for respective UE, the time and frequency resource for scheduling PSCCH and PSSCH and input the information to the base station RRC information configuration module 194. The base station RRC information configuration module 194 may determine whether to generate the third parameter in a SL resource pool configuration. The base station RRC information configuration module 194 may provide information of the third parameter to the base station SL control module 196. The base station SL control module 196 may determine a size of a frequency resource assignment included in the DCI format 3_0 based on whether the base station RRC information configuration module 194 generates the third parameter in the SL resource pool configuration or not.

The base station SL control module 196 may generate a DCI format 3_0 to indicate frequency and time resources of PSSCH to a UE 102. The base station SL control module 196 may generate a DCI format 3_0 to indicate frequency and time resources of PSSCH to a UE 102.

The base station operations module 182 may provide the benefit of performing PDCCH candidate search and monitoring efficiently. The base station operations module 182 may provide information 190 to the one or more receivers 178. For example, the base station operations module 182 may inform the receiver(s) 178 when or when not to receive transmissions based on the RRC message (e.g., broadcasted system information, RRC reconfiguration message), MAC control element, and/or the DCI (Downlink Control Information).

The base station operations module 182 may provide information 188 to the demodulator 172. For example, the base station operations module 182 may inform the demodulator 172 of a modulation pattern anticipated for transmissions from the UE(s) 102.

The base station operations module 182 may provide information 186 to the decoder 166. For example, the base station operations module 182 may inform the decoder 166 of an anticipated encoding for transmissions from the UE(s) 102.

The base station operations module 182 may provide information 101 to the encoder 109. The information 101 may include data to be encoded and/or instructions for encoding. For example, the base station operations module 182 may instruct the encoder 109 to encode transmission data 105 and/or other information 101.

In general, the base station operations module 182 may enable the base station 160 to communicate with one or more network nodes (e.g., a NG mobility management function, a NG core UP functions, a mobility management entity (MME), serving gateway (S-GW), gNBs). The base station operations module 182 may also generate a RRC reconfiguration message to be signaled to the UE 102.

The encoder 109 may encode transmission data 105 and/or other information 101 provided by the base station operations module 182. For example, encoding the data 105 and/or other information 101 may involve error detection and/or correction coding, mapping data to space, time and/or frequency resources for transmission, multiplexing, etc. The encoder 109 may provide encoded data 111 to the modulator 113. The transmission data 105 may include network data to be relayed to the UE 102.

The base station operations module 182 may provide information 103 to the modulator 113. This information 103 may include instructions for the modulator 113. For example, the base station operations module 182 may inform the modulator 113 of a modulation type (e.g., constellation mapping) to be used for transmissions to the UE(s) 102. The modulator 113 may modulate the encoded data 111 to provide one or more modulated signals 115 to the one or more transmitters 117.

The base station operations module 182 may provide information 192 to the one or more transmitters 117. This information 192 may include instructions for the one or more transmitters 117. For example, the base station operations module 182 may instruct the one or more transmitters 117 when to (or when not to) transmit a signal to the UE(s) 102. The base station operations module 182 may provide information 192, including the PDCCH monitoring occasions and DCI format size, to the one or more transmitters 117. The base station operation module 182 may inform the transmitter(s) 117 when or where to transmit the PDCCH candidate for DCI formats with which DCI size. The one or more transmitters 117 may upconvert and transmit the modulated signal(s) 115 to one or more UEs 102.

It should be noted that one or more of the elements or parts thereof included in the base station(s) 160 and UE(s) 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

A base station may generate a RRC message including the one or more RRC parameters, and may transmit the RRC message to a UE. A UE may receive, from a base station, a RRC message including one or more RRC parameters. The term ‘RRC parameter(s)’ in the present disclosure may be alternatively referred to as ‘RRC information element(s)’. A RRC parameter may further include one or more RRC parameter(s). In the present disclosure, a RRC message may include system information. a RRC message may include one or more RRC parameters. A RRC message may be sent on a broadcast control channel (BCCH) logical channel, a common control channel (CCCH) logical channel or a dedicated control channel (DCCH) logical channel.

In the present disclosure, a description ‘a base station may configure a UE to’ may also imply/refer to ‘a base station may transmit, to a UE, an RRC message including one or more RRC parameters’. Additionally or alternatively, ‘RRC parameter configure a UE to’ may also refer to ‘a base station may transmit, to a UE, an RRC message including one or more RRC parameters’. Additionally or alternatively, ‘a UE is configured to’ may also refer to ‘a UE may receive, from a base station, an RRC message including one or more RRC parameters’.

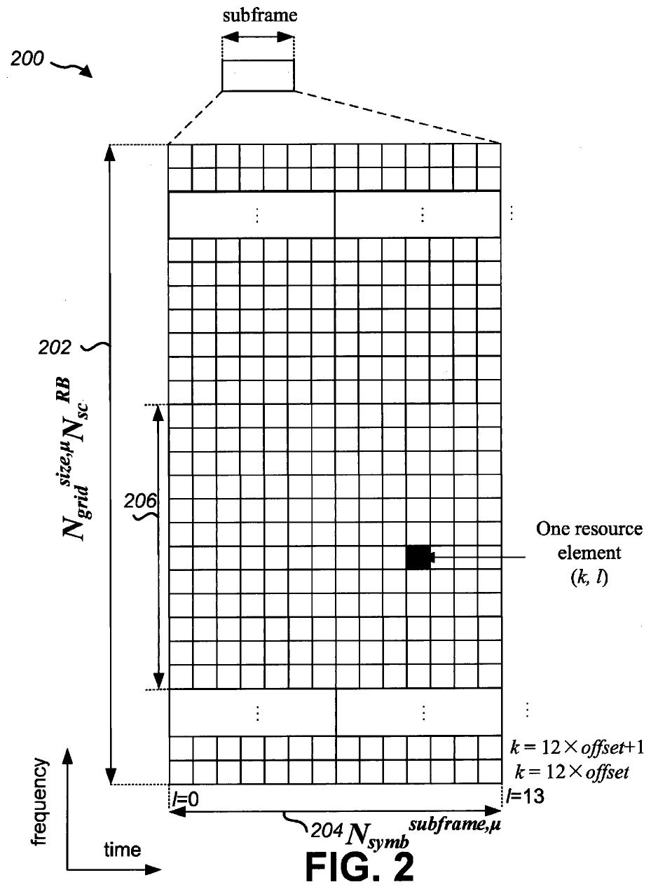

FIG. 2 is a diagram illustrating one example of a resource grid 200.

For each numerology and carrier, a resource grid of N_{grid,x}^{size,μ} N_{sc}^{RB} subcarriers and N_{symb}^{subframe,μ} OFDM symbols is defined, starting at common resource block N_{grid}^{start,μ} indicated by higher layer signaling. There is one set of resource grids per transmission direction (uplink or downlink) with the subscript x set to DL and UL for downlink and uplink, respectively. There is one resource grid for a given antenna port p, subcarrier spacing configuration μ, and the transmission direction (downlink or uplink). When there is no risk for confusion, the subscript x may be dropped.

In the FIG. 2, the resource gird 200 includes the N_{grid,x}^{size,μ} N_{sc}^{RB} (202) subcarriers in the frequency domain and includes N_{symb}^{subframe,μ} (204) symbols in the time domain. In the FIG. 2, as an example for illustration, the subcarrier spacing configuration μ is set to 0. That is, in the FIG. 2, the number of consecutive OFDM symbols N_{symb}^{subframe,μ} (204) per subframe is equal to 14.

The carrier bandwidth N_{grid}^{size,μ} (N_{grid,x}^{size,μ}) for subcarrier spacing configuration μ is given by the higher-layer (RRC) parameter carrierBandwidth in the SCS-SpecificCarrier IE. The starting position N_{grid}^{start,μ} for subcarrier spacing configuration μ is given by the higher-layer parameter offsetToCarrier in the SCS-SpecificCarrier IE. The frequency location of a subcarrier refers to the center frequency of that subcarrier.

In the FIG. 2, for example, a value of offset is provided by the higher-layer parameter offsetToCarrier That is, k=12×offset is the lowest usable subcarrier on this carrier.

Each element in the resource grid for antenna port p and subcarrier spacing configuration μ is called a resource element and is uniquely identified by (k, l)_{p,μ} where k is the index in the frequency domain and l refers to the symbols position in the time domain relative to same reference point. The resource element consists of one subcarrier during one OFDM symbol.

A resource block is defined as N_{sc}^{RB}=12 consecutive subcarriers in the frequency domain. As shown in the FIG. 2, a resource block 206 includes 12 consecutive subcarriers in the frequency domain. Resource block can be classified as common resource block (CRB) and physical resource block (PRB).

Common resource blocks are numbered from 0 and upwards in the frequency domain for subcarrier spacing configuration U. The center of subcarrier 0 of common resource block with index 0 (i.e. CRB0) for subcarrier spacing configuration μ coincides with point A. The relation between the common resource block number

$${n}_{CRB}^{μ}$$

in the frequency domain and resource element (k, l) for subcarrier spacing configuration μ is given by Formula (1) n_{CRB}^{μ}=floor(k/N_{sc}^{RB}) where k is defined relative to the point A such that k=0 corresponds to the subcarrier centered around the point A. The function floor(A) hereinafter is floor operation to output a maximum integer not larger than the A.

Point A refers to as a common reference point. Point A coincides with subcarrier 0 (i.e., k=0) of a CRB 0 for all subcarrier spacing. Point A can be obtained from a RRC parameter offsetToPointA or a RRC parameter absoluteFrequencyPointA. The RRC parameter offsetToPointA is used for a PCell downlink and represents the frequency offset between point A and the lowest subcarrier of the lowest resource block, which has the subcarrier spacing provided by a higher-layer parameter subCarrierSpacingCommon and overlaps with the SS/PBCH block used by the UE for initial cell selection, expressed in units of resource blocks assuming 15 kHz subcarrier spacing for frequency range (FR) 1 and 60 kHz subcarrier spacing for frequency range (FR2). FR1 corresponds to a frequency range between 410 MHz and 7125 MHz. FR2 corresponds to a frequency range between 24250 MHz and 52600 MHz. The RRC parameter absoluteFrequencyPointA is used for all cased other than the PCell case and represents the frequency-location of point A expressed as in ARFCN. The frequency location of point A can be the lowest subcarrier of the carrier bandwidth (or the actual carrier). Additionally, point A may be located outside the carrier bandwidth (or the actual carrier).

As above mentioned, the information element (IE) SCS-SpecificCarrier provides parameters determining the location and width of the carrier bandwidth or the actual carrier. That is, a carrier (or a carrier bandwidth, or an actual carrier) is determined (identified, or defined) at least by a RRC parameter offsetToCarrier, a RRC parameter subcarrierSpacing, and a RRC parameter carrierBandwidth in the SCS-SpecificCarrier IE.

The subcarrierSpacing indicates (or defines) a subcarrier spacing of the carrier. The offsetToCarrier indicates an offset in frequency domain between point A and a lowest usable subcarrier on this carrier in number of resource blocks (e.g. CRBs) using the subcarrier spacing defined for the carrier. The carrierBandwidth indicates width of this carrier in number of resource blocks (e.g. CRBs or PRBs) using the subcarrier spacing defined for the carrier. A carrier includes at most 275 resource blocks.

Physical resource blocks for subcarrier spacing configuration μ are defined within a bandwidth part and numbered form 0 to N_{BWP,i}^{size,μ} where i is the number of the bandwidth part. The relation between the physical resource block n_{PRB}^{μ} in bandwidth part (BWP) i and the common resource block n_{CRB}^{μ} is given by Formula (2) n_{CRB}^{μ}=n_{PRB}^{μ}+N_{BWP,i}^{start, μ} where N_{BWP,i}^{start, μ} is the common resource block where bandwidth part i starts relative to common resource block 0 (CRB0). When there is no risk for confusion the index p may be dropped.

A BWP is a subset of contiguous common resource block for a given subcarrier spacing configuration μ on a given carrier. To be specific, a BWP can be identified (or defined) at least by a subcarrier spacing μ indicated by the RRC parameter subcarrierSpacing, a cyclic prefix determined by the RRC parameter cyclicPrefix, a frequency domain location, a bandwidth, an BWP index indicated by bwp-Id and so on. The locationAndBandwidth can be used to indicate the frequency domain location and bandwidth of a BWP. The value indicated by the locationAndBandwidth is interpreted as resource indicator value (RIV) corresponding to an offset (a starting resource block) RBₛₜₐᵣₜ and a length L_{RB} in terms of contiguously resource blocks. The offset RBₛₜₐᵣₜ is a number of CRBs between the lowest CRB of the carrier and the lowest CRB of the BWP. The N_{BWP,i}^{start, μ} is given as Formula (3) N_{BWP,i}^{start, μ}=O_{carrier}+RBₛₜₐᵣₜ. The value of O_{carrier} is provided by offsetTocarrier for the corresponding subcarrier spacing configuration μ.

A UE 102 configured to operate in BWPs of a serving cell, is configured by higher layers for the serving cell a set of at most four BWPs in the downlink for reception. At a given time, a single downlink BWP is active. The bases station 160 may not transmit, to the UE 102, PDSCH and/or PDCCH outside the active downlink BWP. A UE 102 configured to operate in BWPs of a serving cell, is configured by higher layers for the serving cell a set of at most four BWPs for transmission. At a given time, a single uplink BWP is active. The UE 102 may not transmit, to the base station 160, PUSCH or PUCCH outside the active BWP. The specific signaling (higher layers signaling) for BWP configurations are described later.

A UE 102, configured to operate in a SL BWP, is configured or pre-configured by higher layers for the serving cell or by a pre-configuration a SL BWP for sidelink reception and/or transmission. At a given time, a single SL BWP is active. The UE 102 may not transmit, to another UE 102, sidelink channel (PSCCH, PSCCH, and/or PSFCH) outside the active SL BWP.

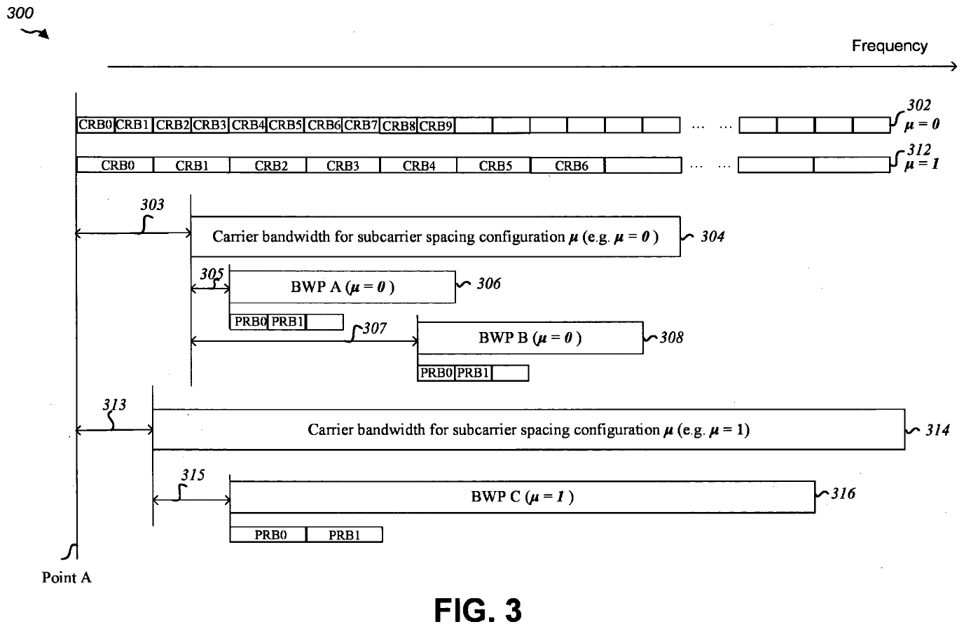

FIG. 3 is a diagram illustrating one example 300 of common resource block grid, carrier configuration and BWP configuration by a UE 102 and a base station 160.

Point A 301 is a lowest subcarrier of a CRB0 for all subcarrier spacing configurations. The CRB grid 302 and the CRB grid 312 are corresponding to two different subcarrier spacing configurations. The CRB grid 302 is for subcarrier spacing configuration μ=0 (i.e. the subcarrier spacing with 15 kHz). The CRB grid 312 is for subcarrier spacing configuration μ=1 (i.e., the subcarrier spacing with 30 kHz).

One or more carriers are determined by respective SCS-SpecificCarrier IEs, respectively. In the FIG. 3, the carrier 304 uses the subcarrier spacing configuration μ=0. And the carrier 314 uses the subcarrier spacing configuration μ=1. The starting position N_{grid}^{start,μ} of the carrier 304 is given based on the value of an offset 303 (i.e. O_{carrier}) indicated by an offsetToCarrier in an SCS-SpecificCarrier IE. As shown in the FIG. 3, for example, the offsetToCarrier indicates the value of the offset 303 as O_{carrier}=3. That is, the starting position N_{grid}^{start,μ} of the carrier 304 corresponds to the CRB3 of the CRB grid 302 for subcarrier spacing configuration μ=0. In the meantime, the starting position N_{grid}^{start,μ} of the carrier 314 is given based on the value of an offset 313 (i.e. O_{carrier}) indicated by an offsetToCarrier in another SCS-SpecificCarrier IE. For example, the offsetToCarrier indicates the value of the offset 313 as O_{carrier}=1. That is, the starting position N_{grid}^{start,μ} of the carrier 314 corresponds to the CRB1 of the CRB grid 312 for subcarrier spacing configuration μ=1. A carrier using different subcarrier spacing configurations can occupy different frequency ranges.

As above-mentioned, a BWP is for a given subcarrier spacing configuration μ. One or more BWPs can be configured for a same subcarrier spacing configuration μ. For example, in the FIG. 3, the BWP 306 is identified at least by the μ=0, a frequency domain location, a bandwidth (L_{RB}), and an BWP index (index A). The first PRB (i.e. PRB0) of a BWP is determined at least by the subcarrier spacing of the BWP, an offset derived by the locationAndBandwidth and an offset indicated by the offsetToCarrier corresponding to the subcarrier spacing of the BWP. An offset 305 (RBₛₜₐᵣₜ) is derived as 1 by the locationAndBandwidth. According to the Formulas (2) and (3), the PRB0 of BWP 306 corresponds to CRB 4 of the CRB grid 302, and the PRB1 of BWP 306 corresponds to CRB 5 of the CRB grid 302, and so on.

Additionally, in the FIG. 3, the BWP 308 is identified at least by the μ=0, a frequency domain location, a bandwidth (L_{RB}), and an BWP index (index B). For example, an offset 307 (RBₛₜₐᵣₜ) is derived as 6 by the locationAndBandwidth. According to the Formulas (2) and (3), the PRB0 of BWP 308 corresponds to CRB 9 of the CRB grid 302, and the PRB1 of BWP 308 corresponds to CRB 10 of the CRB grid 302, and so on.

Additionally, in the FIG. 3, the BWP 316 is identified at least by the μ=1, a frequency domain location, a bandwidth (L_{RB}), and an BWP index (index C). For example, an offset 315 (RBₛₜₐᵣₜ) is derived as 1 by the locationAndBandwidth. According to the Formulas (2) and (3), the PRB0 of BWP 316 corresponds to CRB 2 of the CRB grid 312, and the PRB1 of BWP 316 corresponds to CRB 3 of the CRB grid 312, and so on.

In the present disclosure, a BWP illustrated in the FIG. 3 may refer to a DL BWP, a UL BWP, or a sidelink BWP.

As shown in the FIG. 3, a carrier with the defined subcarrier spacing locate in a corresponding CRB grid with the same subcarrier spacing. A BWP with the defined subcarrier spacing locate in a corresponding CRB grid with the same subcarrier spacing as well.

A base station may transmit a RRC message including one or more RRC parameters related to BWP configuration to a UE. A UE may receive the RRC message including one or more RRC parameters related to BWP configuration from a base station. For each cell, the base station may configure at least an initial DL BWP, one initial uplink bandwidth parts (initial UL BWP) and one sidelink BWP to the UE. Furthermore, the base station may configure additional UL and DL BWPs to the UE for a cell.

SIB1, which is a cell-specific system information block (SystemInformationBlock, SIB), may contain information relevant when evaluating if a UE is allowed to access a cell and define the scheduling of other system information. SIB1 may also contain radio resource configuration information that is common for all UEs and barring information applied to the unified access control. The RRC parameter ServingCellConfigCommon is used to configure cell specific parameters of a UE's serving cell. The RRC parameter ServingCellConfig is used to configure (add or modify) the UE with a serving cell, which may be the SpCell or an SCell of an MCS or SCG. The RRC parameter ServingCellConfig herein are mostly UE specific but partly also cell specific.

The base station may configure the UE with a RRC parameter BWP-Downlink and a RRC parameter BWP-Uplink. The RRC parameter BWP-Downlink can be used to configure an additional DL BWP. The RRC parameter BWP-Uplink can be used to configure an additional UL BWP. The base station may transmit the BWP-Downlink and the BWP-Uplink which may be included in RRC parameter ServingCellConfig to the UE.

The UE may be configured by the based station, at least one initial BWP and up to 4 additional BWP(s). One of the initial BWP and the configured additional BWP(s) may be activated as an active BWP. The UE may monitor DCI format, and/or receive PDSCH in the active DL BWP. The UE may not monitor DCI format, and/or receive PDSCH in a DL BWP other than the active DL BWP. The UE may transmit PUSCH and/or PUCCH in the active UL BWP. The UE may not transmit PUSCH and/or PUCCH in a BWP other than the active UL BWP.

As above-mentioned, a UE may monitor DCI format in the active DL BWP. To be more specific, a UE may monitor a set of PDCCH candidates in one or more CORESETs on the active DL BWP on each activated serving cell configured with PDCCH monitoring according to corresponding search space set where monitoring implies decoding each PDCCH candidate according to the monitored DCI formats.

A set of PDCCH candidates for a UE to monitor is defined in terms of PDCCH search space sets. A search space set can be a CSS set or a USS set. A UE may monitor a set of PDCCH candidates in one or more of the search space sets.

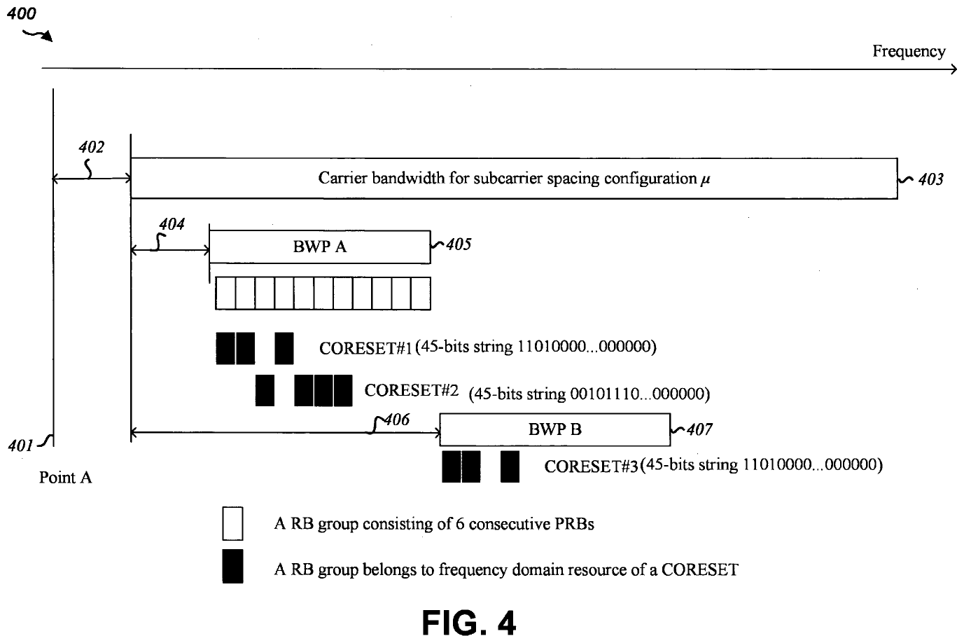

FIG. 4 is a diagram illustrating one 400 example of CORESET configuration in a BWP by a UE 102 and a base station 160.

FIG. 4 illustrates that a UE 102 is configured with three CORESETs for receiving PDCCH transmission in two BWPs. In the FIG. 4, 401 represent point A. 402 is an offset in frequency domain between point A 401 and a lowest usable subcarrier on the carrier 403 in number of CRBs, and the offset 402 is given by the offsetToCarrier in the SCS-SpecificCarrier IE. The BWP 405 with index A and the carrier 403 are for a same subcarrier spacing configuration μ. The offset 404 between the lowest CRB of the carrier and the lowest CRB of the BWP in number of RBs is given by the locationAndBandwidth included in the BWP configuration for BWP A. The BWP 407 with index B and the carrier 403 are for a same subcarrier spacing configuration μ. The offset 406 between the lowest CRB of the carrier and the lowest CRB of the BWP in number of RBs is given by the locationAndBandwidth included in the BWP configuration for BWP B.

For the BWP 405, two CORESETs are configured. As above-mentioned, a RRC parameter frequencyDomainResource in respective CORESET configuration indicates the frequency domain resource for respective CORESET. In the frequency domain, a CORESET is defined in multiples of RB groups and each RB group consists of 6 RBs. For example, in the FIG. 4, the RRC parameter frequencyDomainResource provides a bit string with a fixed size (e.g. 45 bits) as like ‘11010000 . . . 000000’ for CORESET #1. That is, the first RB group, the second RB group, and the fourth RB group belong to the frequency domain resource of the CORESET #1. Additionally, the RRC parameter frequencyDomainResource provides a bit string with a fixed size (e.g. 45 bits) as like ‘00101110 . . . 000000’ for CORESET #2. That is, the third RB group, the fifth RB group, the sixth RB group and the seventh RB group belong to the frequency domain resource of the CORESET #2.

For the BWP 407, one CORESET is configured. As above-mentioned, a RRC parameter frequencyDomainResource in the CORESET configuration indicates the frequency domain resource for the CORESET #3.In the frequency domain, a CORESET is defined in multiples of RB groups and each RB group consists of 6 RBs. For example, in the FIG. 4, the RRC parameter frequencyDomainResource provides a bit string with a fixed size (e.g. 45 bits) as like ‘11010000 . . . 000000’ for CORESET #3. That is, the first RB group, the second RB group, and the fourth RB group belong to the frequency domain resource of the CORESET #3. Although the bit string configured for CORESET #3 is same as that for CORESET #1, the first RB group of the BWP B is different from that of the BWP A in the carrier. Therefore, the frequency domain resource of the CORESET #3 in the carrier is different from that of the CORESET #1 as well.

For the communication system, spectrum is divided into licensed spectrum and unlicensed spectrum. The NR technologies have been developed in the licensed spectrum and in the unlicensed spectrum. The operation in unlicensed spectrum, used as a complementary solution, can increase the throughput of the overall wireless communication system. However, operation in unlicensed spectrum is subject to regulatory limitations and restrictions. For example, the European Telecommunications Standards Institute (ETSI) has defined regulations for operation over the unlicensed spectrum. For example, the occupied channel bandwidth (OCB), which is defined as a bandwidth containing 99% of the signal power, should be larger than a percentage of the nominal channel bandwidth (NCB). For example, according to the ETSI regulations, the OCB should be between 70% and 100% of the NCB for 5 GHz band.

An unlicensed band (or a carrier, or a subband) would be divided into one or multiple non-overlapping channels of 20 MHz bandwidth in the frequency domain. For a (nominal) channel bandwidth of 20 MHz, one transmission should occupy a channel bandwidth larger than what the regulation on OCB requires, for example, one transmission should be larger than 80% of the channel bandwidth of 20 MHz to meet the OCB requirement. To meet the OCB requirement, the design of interlaced transmission had been introduced where each interlace transmission within a channel bandwidth can occupy a channel bandwidth being larger than what the OCB requires.

Interlaced transmission had been introduced to ensure the compliance with the regulations on OCB and NCB requirements. Specifically, the interlaced transmission is designed such that each interlace can occupy the channel bandwidth where the occupied channel bandwidth can fulfill the requirement of the OCB.

An interlace includes a set of resource blocks that are spread out across the bandwidth of a carrier in the frequency domain. A number of interlaces M is subject to the value of a SCS. That is, the number of interlaces M may be predefined according to a specific SCS. For example, if the SCS is equal to 15 kHz, the number of resource block interlaces M is correspondingly equal to 10. If the SCS is equal to 30 kHz, the number of resource block interlaces M is correspondingly equal to 5.

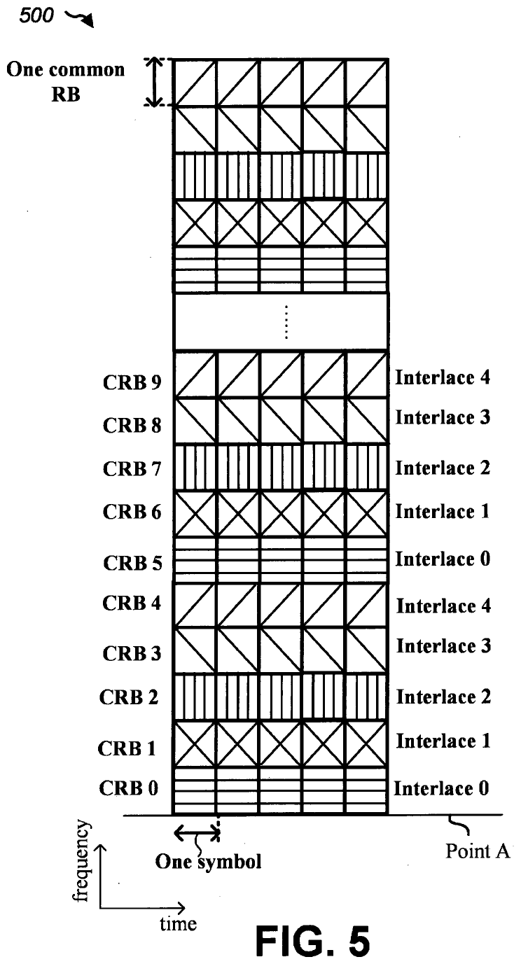

FIG. 5 is a diagram illustrating one example 500 for interlaced resource blocks for transmission and reception. In the FIG. 5, each block in the frequency domain refers to a common resource block. In the FIG. 5, the subcarrier spacing is configured as 30 kHz and the number of resource block interlaces, which is denoted as M, are 5. Then the interlaces are indexed from 0 to M−1. That is, an interlace m, where m=0, 1, . . . , M−1, consists of a plurality of common resource blocks with indexes {m, M+m, 2M+m, 3M+m, . . . }. For example, in the FIG. 5, the interlace m=0 consists of common resource blocks with indexes {0, 5, 10, 15, . . . }, the interlace m=1 consists of common resource blocks with indexes {1, 6, 11, 16, . . . }, and so on.

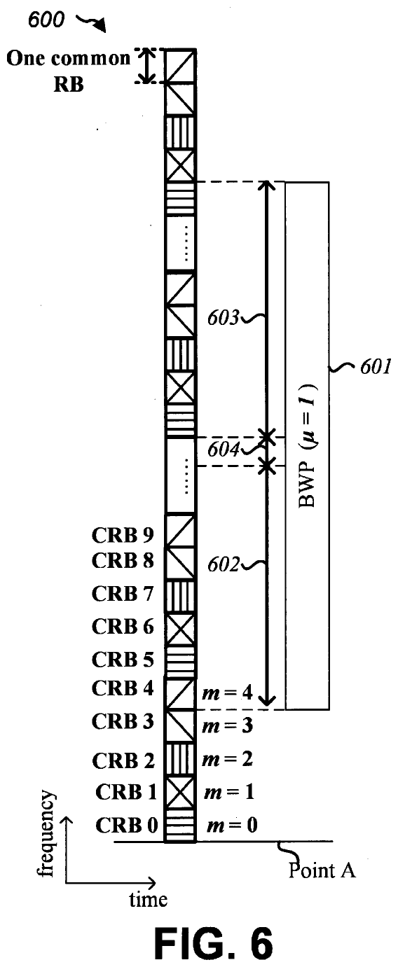

FIG. 6 is a diagram illustrating one example 600 of interlaced mapping for a BWP. In the FIG. 6, the subcarrier spacing is configured as 30 kHz and the number of resource block interlaces M are 5. In the frequency domain, a BWP 601 is determined as illustrated in FIG. 3.

An interlaced resource block in the BWP is denoted as

$${n}_{IRB , m}^{μ}$$

where the

$${n}_{IRB , m}^{μ}$$

is indexed from 0, 1, . . . , in the BWP. The relation between the interlace resource block

$${n}_{IRB , m}^{μ}$$

and interlace m and the common resource block

$${n}_{CRB}^{μ}$$

is given by

$${n}_{CRB}^{μ} = {Mn}_{IRB , m}^{μ} + {N}_{BWP}^{start , μ} + ( ( m - {N}_{BWP}^{start , μ} ) mod M ) .$$

### The

$${N}_{BWP}^{start , μ}$$

is the common resource block where the BWP starts relative to common resource block 0 (i.e., a common resource block with index 0). In the FIG. 6, the BWP 601 starts in a CRB with index 4 relative to the CRB with index 0.

At least for NR-U operation in, for example, 5 GHz spectrum, a BWP may have a bandwidth of multiple of 20 MHz. A sub-band may comprise 20 MHz or a multiple of 20 MHz bandwidth. A sub-band may also be referred to as a sub-channel, or a channel access bandwidth (e.g., a channel of 20 MHz). Then a BWP may include one or more sub-bands in the frequency domain. A sub-band consists of multiple non-overlapping RBs. The number of resource blocks within a sub-band may depend on the SCS of the BWP. For example, the sub-band size for SCS=15 kHz may be equal to 108 for a 40 MHz BWP, and the sub-band size for SCS=30 kHz may be equal to 53 for a 40 MHz BWP. That is, a sub-band is an RB set of non-overlapping and contiguous (common) resource blocks. And a sub-band can be defined by a starting common RB and an ending common RB in the frequency domain. Hereinafter, an RB set is used to refer to a sub-band. In other words, an RB set consists of non-overlapping resource blocks and can be defined by a starting common RB and an ending common RB.

As in the FIG. 6, the BWP 601 includes two RB sets, i.e., a RB set 602 and a RB set 603. The RB sets within a BWP can be indexed from 0 in an increase order along with the frequency. According to higher layer (RRC) configurations, there may be a gap 604 between two consecutive RB set. The gap in unit of resource block can be indicated by the higher layer configurations. Additionally or alternatively, there may be no gap between two RB sets. In other words, there may be a separation of zero, one, or more RBs between two contiguous RB sets within the BWP in the frequency domain.

In the FIG. 6, in the frequency domain, a interlace whose RBs have a lowest CRB index within the first RB set is the interlace m=4, while the interlace whose RBs have a lowest CRB index within the second RB set is the m=0.

In order to ensure a fair co-existence with another NR-U node and/or another radio access technology (RAT) node such as wireless LAN node, the base station 160 and/or the UE 102 may have to perform Listen Before Talk (LBT) procedure before their transmissions. LBT procedure is also referred to as Channel Access procedure. The base station 160 and/or the UE 102 may perform the channel access procedure to determine if there is the presence of other transmission in a channel before their transmission. There may be several types of Channel Access (CA) procedures. For example, Cat-1 LBT is a channel access procedure without channel sensing. Cat-2 LBT is a channel access procedure with one shot channel sensing. Cat-2 LBT may also be referred to as Type-2 channel access procedure. Cat-1 and Cat-2 LBTs may be allowed only inside COT. Cat-3 LBT is a channel access procedure with random backoff with a fixed contention window (CW) size. Cat-4 LBT is a channel access procedure with random backoff with an adaptive CW size. Cat-4 LBT may also be referred to as Type-1 channel access procedure.

In a BWP, before a gNB and/or a UE attempt to transmit a signal, the gNB and/or the UE may first perform channel sensing in each RB set to check whether a channel (or one or more RB sets within the BWP allocated for transmission) is available or not for transmission. If the channel or the allocated RB set(s) is sensed to be considered to be idle (i.e., the channel is available for transmission or the gNB and/or the UE gets a channel access successfully), the gNB and/or the UE may transmit on the channel or on the allocated RB set(s). On the other hand, if the channel or the allocated RB set(s) is sensed to be considered to be busy (i.e., the channel is not available or the gNB and/or the UE does not get a channel access successfully), the gNB and/or the UE may not transmit on the channel or on the allocated RB set(s).

Vehicle-to-everything (V2X) communication technologies have been developed by 3GPP for the automotive industry. V2X refers to a communication technology through which a vehicle exchanges information with another vehicle, a pedestrian, an object having an infrastructure, and so on. The V2X is divided into 4 types, such as vehicle-to-vehicle (V2V), vehicle-to-infrastructure (V2D), vehicle-to-network (V2N), and vehicle-to-pedestrian (V2P). Therefore, the V2X communication is different from the communication between the UEs and gNBs. The V2X communication enables the communication between the UEs, which is also called as sidelink. That is, sidelink communication supports UE-to-UE direct communication via a PC5 interface. In other words, sidelink communication is directly performed or communicated between one transmitting UE and one or more receiving UEs.

Sidelink communication consists of unicast, groupcast and broadcast. The unicast may refer to a communication between two UEs, i.e., one transmitting UE and one receiving UE. The groupcast and/or the broadcast may refer to a communication between one transmitting UE and multiple receiving UEs.

Currently NR Sidelink communication supports two sidelink resource allocation modes, mode 1 and mode 2. The difference between the sidelink resource allocation mode 1 and the sidelink resource allocation mode 2 lies in which determine the resource to be used for the sidelink communication.

In mode 1, the sidelink resource allocation is provided or determined by the base station and/or the network. That is, for mode 1, the base station may manage the resource allocation for the UEs. For example, a base station may allocate the resources for sidelink communication to an in-coverage UE. In sidelink resource allocation mode 1, dynamic grant, configured grant type 1 and configured grant type 2 are supported for PSSCH and PSCCH transmission. In sidelink resource allocation mode 1, for sidelink dynamic grant, the PSSCH transmission is scheduled by a DCI format 3_0. For sidelink configured grant type 1, the configured grant is provided (activated) or released (deactivated) by RRC signaling. For sidelink configured grant type 2, the configured grant is provided or released by PDCCH with the DCI format 3_0.

In mode 2, the sidelink resource allocation is determined by a TX UE itself. The UE may decide the sidelink transmission resources in a resource pool. The UE may carry out the resource allocation without involvement of the base station. These UEs may autonomously determine to select resources for sidelink communication based on a sensing-based procedure.

In mode 1, the DCI format 3_0 is used by the base station for scheduling of NR PSCCH and NR PSSCH in one cell. The base station may determine the scheduling information of NR PSCCH and NR PSSCH and provide the scheduling information to an in-coverage UE. The scheduling information may at least include a Resource pool index field, a time gap field, a HARQ process number field, a New data indicator field, a Lowest index of the subchannel allocation to the initial transmission field, SCI format 1-A fields, and so on. The Resource pool index field is used to indicate an index of a resource pool for which the sidelink transmission is scheduled and the SCI format 1-A fields here refer to the frequency resource assignment field and the time resource assignment field. That is, in mode 1, the base station may determine the time and frequency resource assignment for scheduling of sidelink transmission and then generate the corresponding fields of the scheduling information in the DCI format 3_0. A TX UE (an in-coverage UE) that received the DCI format 30 may transmit the PSCCH with SCI format 1-A and the PSSCH in the resource assigned by the base station based on the scheduling information in the DCI format 3_0. Moreover, the SCI format 1-A transmitted by the TX UE includes the frequency resource assignment field and the time resource assignment field which are as same as those included in the DCI format 3_0. A RX UE (an out-coverage UE and/or an in-coverage UE) that received the PSCCH with the SCI format 1-A can receive the PSSCH in the resource assigned by the base station.

In mode 2, a TX UE may autonomously determine to select resources for sidelink communication and generate the fields in SCI format 1-A to notify an RX UE of the time and frequency resource assignment. The RX UE that received the PSCCH with the SCI format 1-A can receive the PSSCH in the resource assigned by the TX UE.

Sidelink communication supports physical channels such as Physical Sidelink Control Channel (PSCCH), Physical Sidelink Shared Channel (PSSCH), Physical Sidelink Feedback Channel (PSFCH), and Physical Sidelink Broadcast Channel (PSBCH).

The PSCCH is used for transmitting/receiving sidelink control information (e.g., the 1^{st}-stage SCI). For example, the PSCCH indicates resource and other transmission parameters used by a UE for PSSCH reception. PSCCH transmission is associated with a DM-RS. For PSCCH, QPSK is supported.

The PSSCH is used for transmitting/receiving sidelink control information (e.g., the 2^{nd}-stage SCI), transport block(s) of data, and channel state information (CSI). The sidelink control information herein may include information, for example, for HARQ for HARQ procedures and CSI feedback triggers, etc. At least 6 OFDM symbols within a slot are used for PSSCH transmission. PSSCH transmission is associated with a DM-RS and may be associated with a PT-RS. For PSSCH, QPSK, 16QAM, 64QAM and 256QAM are supported.

PSFCH is used for carrying HARQ feedback over the sidelink from a UE which is an intended recipient of a PSSCH transmission to the UE which performed the PSSCH transmission. PSFCH sequence is transmitted in one PRB repeated over two OFDM symbols near the end of the sidelink resource in a slot.

The PSBCH is used for transmitting broadcast information. PSBCH occupies 9 and 7 symbols for normal and extended CP cases respectively, including the associated DM-RS.

Sidelink communication supports physical signals such as demodulation reference signal (DM-RS), phase-tracking reference signal (PT-RS), channel-state information reference signal (CSI-RS), sidelink synchronization signals.

The DMRS(s) are associated with PSCCH, PSSCH and/or PSBCH. A transmitting UE may transmit the DMRS within the associated sidelink physical channel. A receiving UE may use the DMRS to estimate and/or decode the associated sidelink physical channel.

The PT-RS is used to mitigate the effect of phase noise. A transmitting UE may transmit the PT-RS within the PSSCH transmission. The receiving UE may receive the PT-RS and use the PT-RS to mitigate the effect of phase noise.

The CSI-RS is used for measuring channel state information. A transmitting UE may transmit sidelink CSI-RS within a unicast PSSCH transmission. A receiving UE may measure the channel state information by using the CSI-RS and transmit a CSI report based on the measurement to the transmitting UE.

The Sidelink synchronization signal consists of sidelink primary and sidelink secondary synchronization signals (S-PSS, S-SSS), each occupying 2 symbols and 127 subcarriers. The sidelink synchronization signals are transmitted together with the PSBCH in a slot. Specifically, reception occasions of a PSBCH, S-PSS, and S-SSS are in consecutive symbols in a slot and form a S-SS/PBSCH block. For a SL-BWP, the S-SS/PBSCH block has a same SCS as the PSCCH, the PSSCH, and/or the PSFCH.

In various implementations of the present disclosure, a UE may be provided NR sidelink communication (pre-)configuration(s). For simplicity, (pre-)configuration(s) hereinafter refer to the NR sidelink communication (pre-)configuration(s). (Pre-)configuration(s) in the present disclosure may include configuration(s) received by system information (e.g., SIB 12) from a base station, configuration(s) received by dedicated RRC signaling (e.g., RRC configuration/parameters/message) from a base station, and/or configuration(s) preconfigured in the UE (i.e., pre-configuration). Regarding the pre-configuration, a memory unit of the UE may store the pre-configuration in advance.

In various examples or implementations of the present disclosure, (pre-)configuration(s) may include configuration(s) of one or more sidelink BWPs for sidelink communication. That is, a UE may receive the configuration(s) of the one or more BWPs included in system information, in dedicated RRC signaling, and/or in a pre-configuration. In the present disclosure, a UE may be provided by the (pre-)configuration(s) a BWP for sidelink transmissions.

In various examples or implementations of the present disclosure, a SL BWP configuration may include configuration(s) of one or more resource pools for sidelink communication. That is, the configuration(s) of the one or more resource pools (the configuration(s) related to the one or more resource pools) may be received in system information, received in dedicated RRC signaling, and/or preconfigured in a pre-configuration. According to the configuration(s), a resource pool may be indicated to be used either for sidelink communication reception or for sidelink communication transmission. Additionally or alternatively, a resource pool may be indicated to be used for both sidelink communication reception and sidelink communication transmission. Each resource pool is associated with either the sidelink resource allocation Mode 1 or the sidelink resource allocation Mode 2.

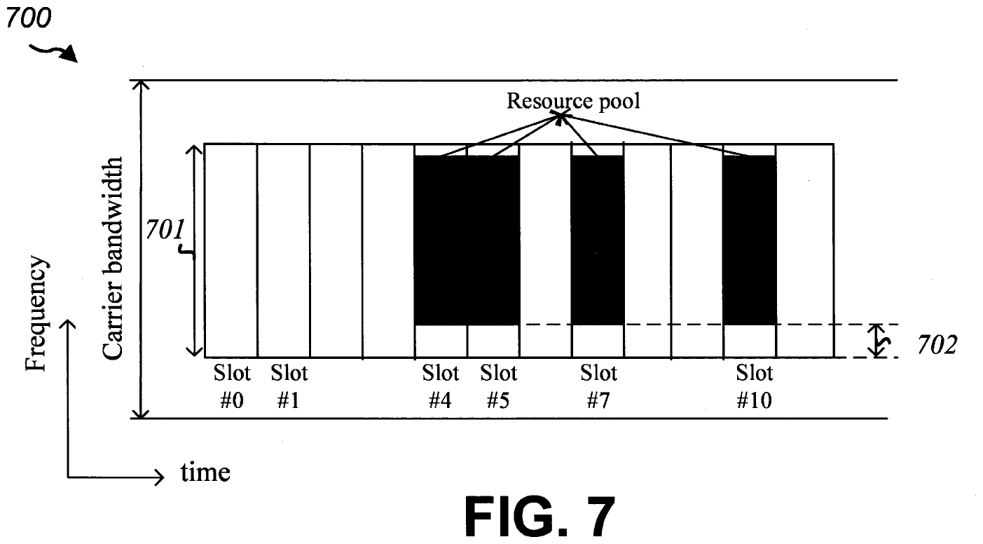

FIG. 7 is a diagram illustrating one example 700 of a SL BWP and a resource pool within the SL BWP.

A UE 102 is provided by a parameter SL-BWP-Config a BWP (a SL BWP) for sidelink transmission with numerology and resource grid. The determination of a SL BWP 701 is similar as how to determine a BWP specified in the FIG. 3.

In the FIG. 7, each block in the time domain represents a slot. One resource pool is configured within the SL BWP 701. The resource pool can be for transmission of PSSCH, PSCCH and/or PSFCH, and/or for reception of PSSCH, PSCCH and/or PSFCH. The first RB of the resource pool relative to the first RB of SL BWP, 702, may be indicated by a parameter included in the (pre-)configurations.

Not all the slots within the SL BWP may be assigned to a resource pool within the SL BWP. That is, not all the slots may belong to a resource pool. A slot assigned to a resource pool (or a slot belongs to a resource pool) can be also referred to a slot available for the resource pool. On the contrary, a slot not assigned to a resource pool (or a slot does not belong to a resource pool) can be also referred to a slot unavailable for the resource pool. Therefore, a resource pool may consist of a plurality (set) of non-contiguous slots in the time domain. In a SL BWP, different resource pools may be assigned with different sets of slots. The UE may determine the set of slots assigned to a resource pool according to the (pre-)configurations. A transmitting UE may transmit one or more physical SL channels or one or more SL signals in one or more resource pools within a SL BWP, while a receiving UE may receive one or more physical SL channels or one or more SL signals in one or more resource pools within a SL BWP.

In the FIG. 7, slot #0 refers to a first slot of a radio frame corresponding to SFN 0 of the serving cell or DFN 0. As illustrated in the FIG. 7, a set of slots with indexes #4, #5, #7 and #10 belong to the resource pool. The slots in the set for a resource pool are re-indexed such that the logical slot indexes are successive from 0 to T′ₘₐₓ−1 where the T′ₘₐₓ is the number of the slot in the set. For example, in the FIG. 7, the four slots in the set can be re-indexed as slots with logical slot indexes 0, 1, 2, and 3. The slots available for a resource pool may be provided or indicated by a parameter sl-TimeResource and may occur with a periodicity of 10240 ms.

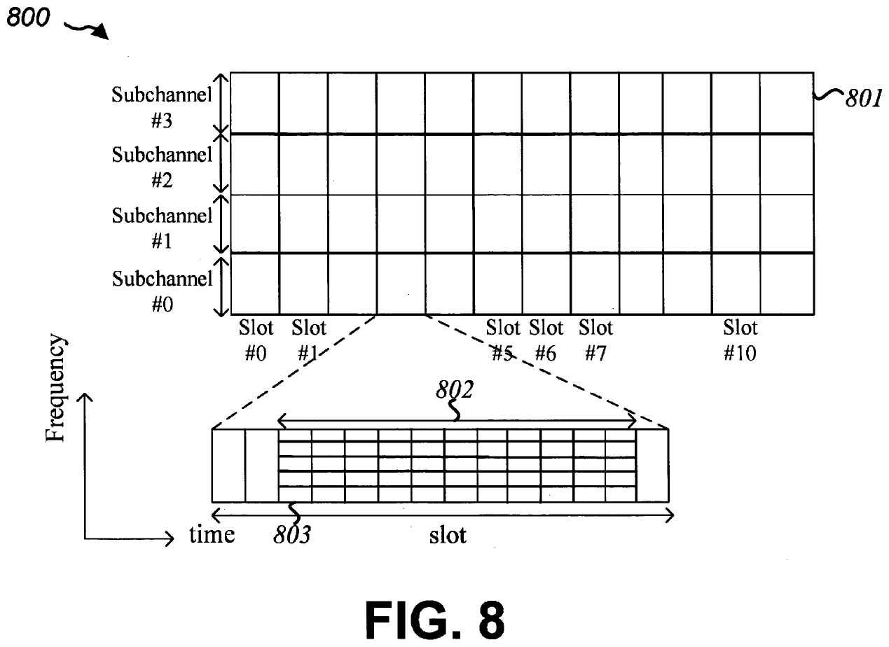

FIG. 8 is a diagram illustrating one example 800 of a resource pool configuration in time and frequency domain. In the FIG. 8, the resource pool is configured with the existing transmission scheme, which is specified in NR Releases 16/17. That is, the resource pool is not configured with the interlaced transmission scheme. For a resource pool configured with the existing transmission scheme, a PSSCH transmission/reception is performed in one or more contiguously allocated sub-channels in the frequency domain where each sub-channel consists of one or more contiguous RBs in the frequency domain.

A resource pool within a SL BWP can be divided into one or multiple contiguous sub-channels in the frequency domain. That is, a resource pool within a SL BWP consists of one or multiple contiguous sub-channels in the frequency domain. The number of the one or multiple sub-channels is indicated by a parameter sl-NumSubchannel included in the configuration of the resource pool. Each sub-channel includes a number of contiguous RBs in the frequency domain. The number of contiguous RBs is indicated by a parameter sl-SubchannelSize included in the configuration of the resource pool. In the FIG. 8, each block in the frequency domain represent a sub-channel of the resource pool 801. For example, in the FIG. 8, the parameter sl-NumSubchannel indicates that the number of one or multiple contiguous sub-channels is 4. That is, the resource pool 801 consists of 4 contiguous sub-channels in the frequency domain. The first RB of the first sub-channel of the resource pool 801 in the SL BWP may be indicated by a parameter sl-StartRB-Subchannel. The first sub-channel of a resource pool refers to a sub-channel with the lowest subchannel index in the resource pool. In the FIG. 8, the subchannel #0 is the first sub-channel of the resource pool 801, that is, the sub-channel with the lowest subchannel index 0. In the frequency domain, the frequency domain resource allocation granularity is one sub-channel for a PSSCH transmission. That is, for PSSCH transmission, the frequency domain unit is a sub-channel. A PSSCH transmission may be performed in one or more contiguous sub-channels in the frequency domain.

In the time domain, each block in the time domain represents a slot in the set of slots assigned to the resource pool 801. The slot indexes in the FIG. 8 refer to the logical slot indexes. The OFDM symbols within a slot assigned for sidelink transmission are provided by parameters included in the (pre-)configuration.

For example, SL transmissions can start from a first symbol indicated by a parameter sl-StartSymbol and be within a number of consecutive symbols indicated by a parameter sl-LengthSymbols. As in the FIG. 8, the duration 802 starts at the third OFDM symbol which is indicated by the parameter sl-StartSymbol and consists of 11 consecutive OFDM symbols which is indicated by the parameter sl-LengthSymbols. For a slot indicated for transmission of S-SS/PSBCH blocks, the first symbol and the number of consecutive symbols is predetermined.

A UE received a PSSCH transmission may transmit sidelink HARQ feedback via PSFCH to another UE which transmitted the PSSCH. Sidelink HARQ feedback can be operated in one of two options. In one option, which can be configured for unicast and groupcast, PSFCH transmits either ACK or NACK using a resource dedicated to a single PSFCH transmitting UE. In another option, which can be configured for groupcast, PSFCH transmits NACK, or no PSFCH signal is transmitted, on a resource that can be shared by multiple PSFCH transmitting UEs. Additionally, in sidelink resource allocation mode 1, a UE which received PSFCH can report sidelink HARQ feedback to gNB via PUCCH or PUSCH.

In NR Releases 16/17, sidelink communication was developed to operate in licensed spectrum. In NR Release 18, to further support commercial use cases with increased sidelink data rate, sidelink communication over unlicensed spectrum is under discussion. As above-mentioned, operation over unlicensed spectrum should fulfill different regulatory limitations and restrictions, e.g., OCB/NCB requirements. Interlaced transmission should be introduced for sidelink communication over unlicensed spectrum such that the regulatory requirement can be fulfilled.

For the sidelink transmissions over unlicensed spectrum, whether the OCB requirement is needed to be complied with is depending on area regulation. Therefore, for an unlicensed spectrum where OCB requirement is not required, the existing transmission scheme for sidelink physical channel and signals, which is specified in 3GPP NR Releases 16 and 17, can be reused for sidelink communication over the unlicensed spectrum. On the other hand, for an unlicensed spectrum where OCB requirement is required, the interlaced transmission scheme can be applied for sidelink communication over the unlicensed spectrum. In the present disclosure, to achieve a flexible and efficient design, a parameter A is introduced to indicate which scheme of the existing transmission scheme and the interlaced transmission scheme is applied for the sidelink transmission in a resource pool or in a SL BWP.

The parameter A may be a common parameter to a plurality of SL resource pools which are configured within a SL BWP. That is, a SL BWP configuration may include the parameter A such that the parameter A is a common indication of which scheme is applied to all the resource pools which are configured in the SL BWP provided by the SL BWP configuration. Specifically, in a case that the SL BWP configuration includes the parameter A, the interlaced transmission scheme is applied to all the resource pools configured in the SL BWP. That is, the UE 102 may determine to use interlaced transmission scheme for sidelink transmission/reception in all the resource pools configured in the SL BWP. In a case that the SL BWP configuration does not include the parameter A, the existing transmission scheme is applied to all the resource pools configured in the SL BWP. That is, the UE 102 may determine to not use interlaced transmission scheme and to use the existing transmission scheme for sidelink transmission/reception in all the resource pools configured in the SL BWP.

Additionally or alternatively, the parameter may be a dedicated parameter specific to a resource pool. That is, a resource pool configuration may include the parameter A such that the parameter A is a specific indication of which scheme is applied for a resource pool provided by the resource pool configuration. Specifically, in a case that a resource pool configuration includes the parameter A, the interlaced transmission scheme is applied to a resource pool configured by the resource pool configuration. That is, the UE 102 may determine to use interlaced transmission scheme for sidelink transmission/reception in the resource pool. In a case that a resource pool configuration does not include the parameter A, the existing transmission scheme is applied to a resource pool configured by the resource pool configuration. That is, the UE 102 may determine to not use interlaced transmission scheme and determine to use the existing transmission scheme for sidelink transmission/reception in the resource pool.

In the present disclosure, the existing transmission scheme can be also referred to as the existing design of sub-channel specified in NR Releases 16 and 17 where a sub-channel consists of contiguous PRBs in the frequency domain. While the interlaced transmission scheme can be also referred to as the new design of sub-channel which would be specified hereinafter. In the present disclosure, the terms “the existing transmission scheme” and “the existing design of sub-channel” may be used interchangeably. The terms “the interlaced transmission scheme” and “the new design of sub-channel” may be used interchangeably. In other words, the above-mentioned parameter A may be a parameter which is used to indicate which of the existing design of sub-channel and the new design of sub-channel is applied to a resource pool.

In the present disclosure, different from the new design of sub-channel, a sub-channel of a resource pool under the new design may consist of multiple contiguous or non-contiguous PRBs in the frequency domain. A sub-channel may be associated with one or more interlaces. A resource pool consists of one or more sub-channels in the frequency domain.

For a carrier with a SCS u, a number of intra-cell guard bands may be configured on the carrier with the SCS u. Each intra-cell guard band is defined by a start common resource block and a size in number of common resource blocks. For each intra-cell guard band, the start common resource block and the size in number of common resource blocks are provided by parameters, for example, parameters startCRB and nrofCRBs, respectively. The size of a guard band can be configured as 0 RB or non-zero RBs. For a carrier, if information of the intra-cell guard bands is not configured by parameters, the intra-cell guard bands may be predefined or predetermined for the carrier with a SCS u.

The intra-cell guard bands separate RB sets in the carrier with the SCS u. The number of intra-cell guard bands on a carrier with a SCS can be denoted as N_{RB-set}−1. That is, the UE is provided with N_{R}B-set−1 intra-cell guard bands on a carrier. The N_{RB-set}−1 intra-cell guard bands separate N_{RB-set} RB sets. That is, the number of RB set for the carrier is N-set. Each RB set is defined by a start common resource block and an end common resource block in the frequency domain. The UE may determine a start common resource block and an end common resource block for an RB set based on the information of the intra-cell guard bands. Then an RB set consists of a plurality of contiguous common resource blocks in the frequency domain. For a carrier with different SCSs, an RB set may include different numbers of common resource blocks. For example, in a case that subcarrier spacing equals to 15 KHz, the number of resource blocks within an RB set may be configured to be between 100 and 110. In a case that subcarrier spacing equals to 30 kHz, the number of resource blocks within an RB set may be configured to be between 50 and 55. However, as an exception, for a resource pool, at most one RB set may be configured to contain 56 resource blocks. Specifically, a single RB set is defined by a starting common RB and an ending common RB in the frequency domain.

A UE may be configured with one or more SL BWP on the carrier with the SCS u. In the frequency domain, a SL BWP may be configured to include one or more RB sets on the carrier. The number of the one or more RB sets within a SL BWP are based on the configured bandwidth of the SL BWP. The one or more RB sets within a SL BWP can be denoted as N_{RB-set}^{BWP} where N_{RB-set}^{BWP} can be less than or equal to N_{RB-set}. The one or more RB sets within a SL BWP are indexed from 0 to N_{RB-set}^{BWP}−1 in the order of increasing frequency of the SL BWP and starting at the lowest frequency.

Likewise, the UE may be configured with one or more SL resource pools within a SL BWP on the carrier with the SCS u. In the frequency domain, a SL resource pool may be configured to include one or more RB sets within the SL BWP on the carrier. The number of RB sets included in a SL resource pool are based on the configured bandwidth of the resource pool. The RB sets included in a SL resource pool can be denoted as N_{RB-set}^{RP} where N_{RB-set}^{RP} can be less than or equal to N_{RB-set}^{BWP}. The RB sets included in a resource pool are indexed from 0 to N_{RB-set}^{RP}−1 in the order of increasing frequency of the resource pool and starting at the lowest frequency.

In the present disclosure, a SL BWP and/or a resource pool may be divided into one or more RB sets, where each of the one or more RB sets does not overlap with each other in the frequency domain. That is, the one or more RB sets do not have overlapping RBs in the frequency domain. The one or more RB sets within the resource pool are indexed from 0 in the order of increasing frequency of the one or more RB sets.

Additionally or alternatively, a guard band including zero, one or multiple RBs may separate two consecutive RB sets amongst the one or more RB sets within a resource pool.

For a resource pool that is configured with interlaced transmission, each RB of the resource pool is mapped to an RB of an interlace m. Furthermore, each RB within a resource pool is mapped to an interlace. In other words, in the present disclosure, a resource pool may consist of a plurality of interlaces. In the frequency domain, a resource pool is divided into a number of interlaces M where each interlace consists of non-contiguous (common) resource blocks. As above-mentioned, the value of M is determined per SCS.

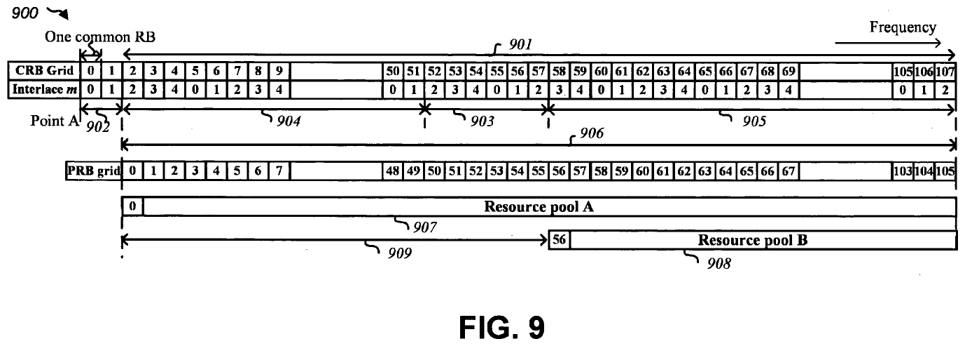

FIG. 9 is a diagram illustrating one example 900 of configurations of a SL BWP and SL resource pools.

As in the FIG. 9, a CRB grid is used to represent the common resource blocks in a carrier with a SCS. That is, a CRB index is used to represent a CRB in the carrier. The CRBs in the carrier are indexed from 0 in an order of increasing frequencies and starting from point A. Here, as an example in the FIG. 9, the carrier 901 uses the subcarrier spacing configuration μ=1, i.e., the SCS=30 kHz. The starting position N_{grid}^{start,μ} of the carrier 901 is given based on the value of an offset 902 (i.e. O_{carrier}) indicated by a parameter (e.g., the above-mentioned offsetToCarrier). That is, the carrier 901 starts from the CRB with index 2, i.e., the N_{grid}^{start,μ}=2, and includes a plurality of contiguous CRBs with index from 2 to 107. That is, the carrier bandwidth N_{grid}^{size,μ} of the carrier 901 in number of RBs is 106.

Each CRB on the carrier is mapped to an interlace m where the mapping between CRBs and interlaces are performed cyclically from 0 to M−1 in an order of increasing frequencies of CRBs. As in the FIG. 9, CRBs on the carrier are mapped to an interlace cyclically from 0 to 4 in the order of increasing frequencies of the CRBs and starting from the lowest frequency of a CRB.

As illustrated in the FIG. 9, a number of intra-cell guard band is equal to 1, i.e., N_{RB-set}−1=1. As above-mentioned, the intra-cell guard band 903 can be defined by a start CRB and a size in number of CRBs provided by a parameter startCRB and a parameter nrofCRBs, respectively. Specifically, the parameter startCRB indicates an RB offset relative to the starting CRB of the carrier 901. A CRB index of a starting CRB of an intra-cell guard band is given by its corresponding parameter startCRB and the N_{grid}^{start,μ} of the carrier 901. In the FIG. 9, the parameter startCRB indicates an RB offset as 50. The starting CRB of the intra-cell guard band 903 is determined by the summation of the RB offset and the N_{grid}^{start,μ}, i.e., the starting CRB of the intra-cell guard band 903 is the CRB with index 52. And the intra-cell guard band 903 includes 6 CRBs that is provided by the parameter nrofCRBs.

Then the intra-cell guard band 903 separates two RB sets 904 and 905 in the carrier 901, i.e., N_{RB-set}=2. Within the carrier, the RB sets are indexed from 0 to N_{RB-set}−1 in an order of increasing frequencies. The RB set 904 can be indexed with 0, i.e., the RB set 904 refers to the RB set 0 within the carrier 901. Likewise, the RB set 905 can be indexed with 1, i.e., the RB set 905 refers to the RB set 1 within the carrier 901.

The starting position (the starting CRB) of the RB set 904 is the starting position N_{grid}^{start,μ} of the carrier 901. The ending CRB of the RB set 904 is determined based on the starting position N_{grid}^{start,μ} of the carrier 901 and the RB offset provided by the parameter startCRB for the intra-cell guard band 903. Additionally, the starting CRB of the RB set 905 is determined based on the starting position N_{grid}^{start,μ} of the carrier 901, the RB offset provided by the parameter startCRB for the intra-cell guard band 903, and the size of the intra-cell guard band 903 by the parameter nrofCRBs. The ending CRB of the RB set 905 is determined based on the starting position N_{grid}^{start,μ} of the carrier 901 and the size N_{grid}^{size,μ} of the carrier 901.

In the present disclosure, a SL BWP can be configured to include one, more or all RB sets within the carrier. In the FIG. 9, a SL BWP 906 is configured to include all RB sets within the carrier 901. That is, the number of RB sets within the SL BWP 906 is same as that within the carrier 901. Likewise, the RB sets within a SL BWP are numbered in increasing order from 0.

A PRB grid is used to represent the physical resource blocks in a SL BWP. That is, a PRB index is used to represent a PRB in the SL BWP. The PRBs in the BWP are indexed from 0 in an order of increasing frequencies. A PRB in a SL BWP corresponds to a CRB in a carrier. Likewise, a PRB in a BWP corresponds to an RB of an interlace m in a carrier. As illustrated in the FIG. 9, the PRB with index 0 corresponds to the CRB with index 2, the PRB with index 1 corresponds to the CRB with index 3, and so on. Likewise, the PRB with index 0 corresponds to an RB of interlace m=2. The PRB with index 1 corresponds to an RB of interlace m=3.

In various examples or various implementations of the present disclosure, one or more SL resource pools can be configured within a SL BWP on the carrier with the SCS u. A SL resource pools can be configured to include one or more RB sets of a SL BWP in the frequency domain. As illustrated in FIG. 9, two SL resource pools, i.e., a SL resource pool 907 and a SL resource pool 908 are configured in the SL BWP 906. The SL resource pool 907 is configured to include the RB set 904, the RB set 905, and the guard band 903 in the frequency domain. The SL resource pool 908 is configured to include the RB set 905 in the frequency domain. That is, different SL resource pools can be configured with different number of RB sets within a SL BWP, which are depending on configured bandwidths of the resource pools. The RB sets included in a SL resource pool can be denoted as N_{RB-set}^{RP} where N_{RB-set}^{RP} can be less than or equal to N_{RB-set}^{BWP}. The RB sets included in a resource pool are indexed from 0 to N_{RB-set}^{RP}−1 in the order of increasing frequency of the resource pool and starting at the lowest frequency. The resource pool 907 includes N_{RB-set}^{RP}=2 RB sets and the resource pool 908 includes N_{RB-set}^{RP}=1 RB set.

In the FIG. 9, the resource pool 907 starts in a RPB with index 0 relative to the starting PRB of the SL BWP (i.e., PRB with index 0), while the resource pool 908 starts in a RPB with index 56 relative to the starting PRB of the SL BWP (i.e., PRB with index 0). A SL BWP and/or a resource pool is configured not to include parts of an RB set. In the present disclosure, a SL BWP and/or a resource pool may be configured to start on an RB with a lowest CRB index within a first RB set and to end an RB with a largest CRB index within a second RB set. The first RB set and the second RB set can refer to a same RB set or different RB sets within the carrier. In other words, a starting RB of a SL BWP and/or a SL resource pool is a starting RB of an RB set. Likewise, an ending (last) RB of a SL BWP and/or a SL resource pool is an ending RB of an RB set.

In the present disclosure, the resource pool may consist of one or more sub-channels. The one or more sub-channels are indexed in increasing order from 0 to N_{subch}−1 where the N_{subch} is the number of the one or more sub-channels included in the resource pool. If the interlaced transmission is configured to apply to the resource pool, to adapt to the interlaced transmission, the mapping between interlaces and the one or more sub-channels of the resource pool is provided. The UE 102 (e.g., the control unit of the UE 102) may determine, which one or more interlaces of the M interlaces are included (or grouped) in a sub-channel of the one or more sub-channels of the resource pool at least based on a parameter B and/or a parameter C.

In other words, the UE 102 may determine, for a sub-channel, a starting interlace index and a number of interlaces based on the parameter B and/or the parameter C.

In an example, the parameter C is introduced to indicate a number of interlaces, K, where the K interlaces are included in a sub-channel. That is, K interlaces are formed to a sub-channel. A sub-channel may consist of K interlaces. The UE may determine the number of the one or more sub-channels N_{subch} based on the parameter C and M. Specifically, the N_{subch} may be determined or calculated as ceiling (M mod K) or as M mod K. The mod function refers to the Modulo operation and the ceiling(A) function hereinafter is to output a smallest integer not less than A. For example, in case of SCS=15 kHz (i.e., M=10), the value of K indicated by the parameter C may be 1, 2, 2.5, 5, or 10. In case of SCS=30 kHz (i.e., M=5), the value of K indicated by the parameter C may be 1, 2.5, or 5. The K interlaces may be also referred to as one or more interlaces. For convenience of description, ceiling (M mod K) and M mod K can be used interchangeably.

Additionally or alternatively, the SL resource pool configuration may not include the parameter C. The UE 102 may determine the value of K as a default value or a predefined value. For example, in a case that the SL resource pool configuration may not include the parameter C, the UE 102 may determine K=1 or K=M. That is, if a SL resource pool configuration aims to set K as the default value, the SL resource pool configuration is not necessary to always include the parameter C so that signaling overhead of the parameter C can be reduced.

In an example, the parameter B is introduced to determine or indicate a starting interlace index m₀. The UE 102 may determine the starting interlace index m₀ based on the parameter B for a resource pool. The starting interlace index m₀ may be used to determine a sub-channel with the lowest index in the resource pool. The starting interlace index m₀ is an interlace of K interlaces included in the lowest sub-channel. The lowest sub-channel refers to a sub-channel with a lowest sub-channel index.

The parameter B may refer to the above-mentioned parameter sl-StartRB-Subchannel. As above-mentioned, the parameter sl-StartRB-Subchannel is used to indicate the first (starting, lowest) RB index of a lowest sub-channel in a resource pool with respect to the lowest RB index of a SL BWP. The lowest RB index of a SL BWP refers to the PRB 0 of the SL BWP. The UE may determine the interlace m₀ based on the parameter B. Specifically, the UE may determine the first RB of the lowest sub-channel based on the parameter B. Then the UE may determine the interlace m₀ wherein the interlace m₀ includes the first RB of the lowest sub-channel. That is, the first RB of the lowest sub-channel is an RB of the interlace m₀.

In an example, the parameter B may be an indication of interlace m₀. The parameter B may be used to indicate an interlace m₀ for a sub-channel within a lowest index within a resource pool or within an RB set of a resource pool.

As illustrated in the FIG. 9, for the resource pool 907, the parameter sl-StartRB-Subchannel indicates 0, that is, the first RB of a lowest sub-channel in the resource pool 907 is the lowest RB index of the SL BWP 906. The RB offset between the resource pool 907 and the SL BWP 906 is zero RB. The first RB of the resource pool 907 is the PRB 0 of the SL BWP 906 where the PRB 0 corresponds to the CRB 2 and is a RB of the interlace m=2. The UE may determine the interlace m₀=2 for the resource pool 907.

Additionally, for the resource pool 908, the parameter sl-StartRB-Subchannel indicates 56, that is, the first RB of a lowest sub-channel in the resource pool 907 is a PRB with index 56 with respect to the lowest RB index of the SL BWP 906. That is, the parameter sl-StartRB-Subchannel indicates the RB offset 909 between the resource pool 908 and the SL BWP 906. The first RB of the resource pool 908 is the PRB 56 of the SL BWP 906 where the PRB 56 corresponds to the CRB 58 and is a RB of the interlace m=3. The RB offset 909 between the resource pool 908 and the SL BWP 906 is 55 RB. The UE may determine the interlace m₀=3 for the resource pool 908. Therefore, in the present disclosure, different resource pools in a same SL BWP may have same or different starting interlaces m₀.

Upon determine the starting interlace index m₀, the UE 102 may determine the K interlace indexes for a sub-channel. The UE 102 may determine that a sub-channel with a lowest index includes the K interlaces with indexes calculated as (m₀+j) mod M for j=0, 1, . . . , K−1. The UE 102 may determine that a sub-channel with an index i includes K interlaces with indexes calculated as ((m₀+floor (i*K)) mod M+j) mod M for j=0, 1, . . . , K−1. The M is 10 in a case that a subcarrier spacing (SCS) of the SL BWP is 15 kHz and 5 in a case that the SCS is 30 kHz. For convenience of description, floor (i*K) and floor (i*K) can be used interchangeably.

In the present disclosure, there are two concepts of designing the sub-channel in a resource pool. One is that a sub-channel is within an RB set. The other one is that a sub-channel is across all the RB sets included in a resource pool.

In the present disclosure, the concept (the first concept) that a sub-channel is within an RB set may imply that RBs of a sub-channel are within an RB set in the frequency domain. The RBs of a sub-channel do not belong to more than one RB set. The UE may determine the K interlaces for a sub-channel. The UE may further determine the RBs of the sub-channel as an intersection of the RBs of the determined K interlaces and a single RB set of the resource pool. According to the first concept of sub-channel, the N_{subch} may be determined or calculated as (M mod K)*N_{RB-set}^{RP}.

There are (M mod K) sub-channels within each RB set. Hereinafter, an RB set r may refer to an RB set with an RB index r. For a resource pool including N_{RB-set}^{RP} RB sets, the RB index r is that r=0, 1, . . . , N_{RB-set}^{RP}−1. The sub-channels within an RB set r have indexes as (M mod K)*r, (M mod K)*r+1, . . . , (M mod K)*(r+1)−1. That is, the sub-channels within an RB set r have indexes as (M mod K)*r+n where n=0, 1, . . . , (M mod K)−1.

According to the first concept of sub-channel, for a sub-channel with index i where i=0, 1, . . . , N_{subch}−1, the UE 102 may determine that a sub-channel with an index i includes K interlaces with indexes calculated as ((m₀+floor (i*K)) mod M+j) mod M for j=0, 1, . . . , K−1. The M is 10 in a case that a subcarrier spacing (SCS) of the SL BWP is 15 kHz and 5 in a case that the SCS is 30 kHz.

Additionally or alternatively, according to the first concept of sub-channel, the UE may determine a starting interlace m_{0,r} for a sub-channel with the lowest index within an RB set r based on a lowest RB index in the RB set r. The UE 102 may determine the first RB of the RB set r wherein the first RB is an RB with a lowest RB index (a lowest CRB index, or a lowest frequency) in the RB set r in the frequency domain. And the UE 102 may determine the interlace m_{0,r} wherein the interlace m_{0,r} includes the first RB of the RB set r. The UE 102 determined that a sub-channel with a lowest index within an RB set r includes the K interlaces with indexes calculated as (m_{0,r}+j) mod M for j=0, 1, . . . , K−1. The UE 102 may determine that, for an RB set r, a sub-channel with an index (M mod K)*r+n includes K interlaces with indexes calculated as ((m_{0,r}+floor (n*K)) mod M+j) mod M for j=0, 1, . . . , K−1.

Upon determining the K interlace indexes for a sub-channel, the UE may further determine the RBs of the sub-channel as an intersection of the RBs of the determined K interlaces and a single RB set of the resource pool. That is, the sub-channel may consist of resource blocks where the resource blocks are an intersection of the RBs of the determined K interlaces and a single RB set of the resource pool. Here the determined K interlaces is the interlaces which are mapped to the sub-channel. The single RB set is an RB set where the sub-channel is located.

In the present disclosure, the concept (the second concept) that a sub-channel is across all the RB sets of the resource pool may imply that RBs of a sub-channel are across all RB sets. The RBs of a sub-channel belong to more than one RB set if the resource pool includes more than one RB set. The UE may determine the K interlaces for a sub-channel. The UE may further determine the RBs of the sub-channel as an intersection of the RBs of the determined K interlaces and all RB sets of the resource pool. A sub-channel may not include the RBs of the determined K interlaces which locate in the intra-cell guard bands included in the resource pool. Additionally or alternatively, the UE may further determine the RBs of the sub-channel as an intersection of the RBs of the determined K interlaces and the union of all RB sets of the resource pool and intra-cell guard bands included in the resource pool. According to this concept of sub-channel, the N_{subch} may be determined or calculated as (M mod K). That is, there are (M mod K) sub-channels within a resource pool.

According to the second concept of sub-channel, for a sub-channel with index i where i=0, 1, . . . , N_{subch}−1, the UE 102 may determine that a sub-channel with an index i includes K interlaces with indexes calculated as ((m₀+floor (i*K)) mod M+j) mod M for j=0, 1, . . . , K−1.

In the present disclosure, the sub-channels in a resource pool may have equal number(s) of interlace(s). Additionally or alternatively, the sub-channels in the resource pool may also have unequal numbers of interlaces. The unequal numbers of interlaces may be determined based on the values of M and K. Specifically, the UE may determine that a resource pool has a first set of sub-channels and a second set of sub-channels wherein a sub-channel in the first set includes the K interlaces and a sub-channel in the second set includes the (M mod K) interlace(s). The second set may include one sub-channel with largest index in a resource pool or in an RB set.

For example, the parameter C may indicate K=2. In case of M=5, the UE may determine first two sub-channels which includes K=2 interlaces and may determine a last sub-channel which include the remaining one interlace. By supporting unequal numbers of interlaces included in sub-channel, a more flexible mapping between a sub-channel and interlaces can be provided, which can enable a more efficient use of interlaces for a SL resource pool.

In the present disclosure, a PSCCH transmission is performed within a sub-channel. As above-mentioned, a sub-channel may include K interlaces where K can be equal to 1 or larger than 1. The UE may receive a parameter D to indicate a number of PRBs in the resource pool where the number of PRBs is for PSCCH transmission in the resource pool. For the purpose of illustration, the parameter D indicates L PRBs for PSCCH in the resource pool. The UE 102 may determine which RBs in a sub-channel to be used as the PRBs for PSCCH transmission. That is, the UE 102 may need to determine L PRBs from the RBs of a sub-channel in the following order, that is, first in increasing order of interlace indexes within the K interlaces, and then in increasing order of the RB indexes within an interlace. The RB indexes may refer to the CRB indexes, the PRB indexes, or the frequencies indexes of RBs. According to the value of L PRBs, L PRBs may be mapped to one or more interlaces of a sub-channel. That is, a PSCCH transmission may be performed in one or more interlaces within an RB set. In a case that a sub-channel is across more than one RB set, the L PRBs for PSCCH should be determined in an RB set with the lowest RB set index among the more than one RB set.

Sidelink control information is split into two stages, i.e., 1^{st}-stage SCI and 2^{nd}-stage SCI. Specifically, SCI carries on PSCCH is the 1^{st}-stage SCI, which transports sidelink scheduling information. That is, the 1^{st}-stage SCI is sent on PSCCH. The SCI carries on PSSCH is the 2^{nd}-stage SCI, which transports sidelink scheduling information, and/or inter-UE coordination related information. That is, the 2^{nd}-stage SCI is send on PSSCH.

The fields of the 1^{st}-stage SCI formats (e.g., the SCI format 1-A) are mapped to the information bits of the 1^{st}-stage SCI. The SCI format 1-A is used for the scheduling of PSSCH and 2^{nd}-stage SCI on PSSCH.

The SCI format 1-A may include the following fields, e.g., Priority, Frequency resource assignment, Time resource assignment, Resource reservation period, DMRS pattern, 2^{nd}-stage SCI format, Beta_offset indicator, Number of DMRS port, Modulation and coding scheme, Additional MCS table indicator, PSFCH overhead indication, Reserved, Conflict information receiver flag. As above-mentioned, in Mode 1, the UE may obtain the time resource assignment field and the frequency resource assignment field from DCI format 3_0 and include them in SCI format 1-A. In mode 2, the UE may determine the resource allocation for sidelink transmission and generate the time resource assignment field and the frequency resource assignment field in SCI format 1-A.

The fields defined in each of the 2^{nd}-stage SCI formats (e.g., the SCI format 2-A, SCI format 2-B, SCI format 2-C) are mapped to the information bits of the 2^{nd}-stage SCI. The SCI format 2-A is used for the decoding of PSSCH, with HARQ operation when HARQ-ACK information includes ACK or NACK, when HARQ-ACK information includes only NACK, or when there is no feedback of HARQ-ACK information. The SCI format 2-B is used for the decoding of PSSCH, with HARQ operation when HARQ-ACK information includes only NACK, or when there is no feedback of HARQ-ACK information. The SCI format 2-C is used for the decoding of PSSCH, and providing inter-UE coordination information or requesting inter-UE coordination information.

In the present disclosure, for the resource allocation of a PSSCH transmission, the time domain unit is a slot (a logical slot) while the frequency domain unit is a sub-channel. A PSSCH transmission or a PSSCH reception may be performed in one or more sub-channels in the frequency domain and in a set of one or more slots in the time domain.

Regarding the time resource allocation behavior, a parameter sl-MaxNumPerReserve is used to indicate a maximum number of reserved PSCCH/PSSCH resources that can be indicated by the SCI format 1-A. The parameter sl-MaxNumPerReserve is configured per resource pool. The value of the parameter sl-MaxNumPerReserve can be configured to 2 or 3, which means an SCI format 1-A can schedule up to 2 or 3 reserved resources for PSCCH/PSSCH transmission in the time domain.

The UE and/or the base station may determine the size of the time resource assignment field based on the value of the parameter sl-MaxNumPerReserve. The UE and/or the base station may determine the size of the time resource assignment field as 5 bits when the value of the higher layer parameter sl-MaxNumPerReserve is configured to 2 and may determine the size of the time resource assignment field as 9 bits when the value of the higher layer parameter sl-MaxNumPerReserve is configured to 3.

The base station may use the time resource assignment field of the DCI format 3_0 to indicate a UE a set of one or more slots for PSSCH transmission. The UE may use the time resource assignment field of an SCI format 1-A to determine a set of one or more slots for PSSCH transmission/reception associated with the SCI format 1-A. The one or more slots in the set can be contiguous or non-contiguous in the time domain. The number of the one or more slots in the set, N, may not be always same as the value of the parameter sl-MaxNumPerReserve. The number of the one or more slots, N, can be smaller than or equal to the value of the parameter sl-MaxNumPerReserve. The one or more slots in the set can be also referred to as the N actual resources for PSSCH transmission/reception.

Specifically, the time resource assignment field carries logical slot offset indications of N=1 or 2 actual resources when sl-MaxNumPerReserve is 2, and N=1 or 2 or 3 actual resources when sl-MaxNumPerReserve is 3, in a form of time RIV (TRIV) field which is determined as follows:

```
if N = 1
  TRIV = 0
elseif N = 2
  TRIV = t₁
else
  if (t₂ − t₁− 1) <= 15
    TRIV = 30 (t₂ − t₁− 1) + t₁ +31
  else
    TRIV = 30 (31 − t₂ + t₁) + 62 − t₁
  end if
end if.
```

Herein, the value of the time resource assignment field can be referred to as a time resource indicator value (TRIV). The first resource among the N resources is in the slot where the SCI format 1-A was received. For illustration, tᵢ denotes i-th resource time offset in logical slots of a resource pool with respect to the first resource where for N=2, 1<=t₁<=31; and for N=3, 1<=t₁<=30, t₁<t₂<=31. For example, when t₁=1, it means the second resource is assigned in a slot adjacent to the first resource.

According to the above formula for TRIV, when the parameter sl-MaxNumPerReserve is configured to 2, the size of the time resource assignment is 5 bits where 1 codepoint (i.e., TRIV=0) indicates no reserved resource, i.e., no second resource reserved, and the remaining 31 codepoints indicate different time positions for the second resource within 31 slots.

Likewise, when the parameter sl-MaxNumPerReserve is configured to 3, the size of the time resource assignment is 9 bits where 1 codepoint (i.e., TRIV=0) indicates no second and third resources reserved; 31 codepoints indicate there is a second resource reserved but no third resource reserved, and further indicate different time positions for the second resource within 31 slots; a part of the remaining codepoints indicate there are a second resource reserved and a third resource reserved, and further indicate different time positions for the second resource and the third resource within 31 slots.

As above-mentioned, the resource allocation unit in the frequency domain is the sub-channel. The frequency resource assignment field is used to indicate one or more sub-channels assigned for PSSCH transmission/reception. In other words, the sub-channel assignment for sidelink (PSSCH) transmission is determined using the frequency resource assignment field in the associated SCI format.

The UE and/or the base station may determine the size of the frequency resource assignment field based on the value of the above-mentioned parameter sl-MaxNumPerReserve. When the value of the parameter sl-MaxNumPerReserve is configured to 2, the UE may determine the size of the frequency resource assignment field as

$$⌈ {log}_{2} ( \frac{{N}_{subchannel}^{SL} ( {N}_{subchannel}^{SL} + 1 )}{2} ) ⌉ .$$

When the value of the parameter sl-MaxNumPerReserve is configured to 3, the UE may determine the size of the frequency resource assignment field as

$$⌈ {log}_{2} ( \frac{{N}_{subchannel}^{SL} ( {N}_{subchannel}^{SL} + 1 ) ( 2 {N}_{subchannel} + 1 )}{6} ) ⌉ .$$

Here ┌A┐ denotes the ceiling operation which is to output a smallest integer not less than A. The N_{subchannel}^{SL} is the number of the one or more sub-channels included in a resource pool, which is indicated by the parameter sl-NumSubchannel included in a configuration of the resource pool. Each sub-channel includes a number of contiguous RBs in the frequency domain. According to the formulas for determining the size of frequency resource assignment field, the UE may determine the size of the frequency resource assignment field based on the parameter sl-MaxNumPerReserve and the parameter sl-NumSubchannel. The size determination herein for the frequency resource assignment field may be applied to a resource pool which is configured with the existing transmission scheme.

The frequency resource assignment field provides a frequency RIV (FRIV). That is, the value of the frequency resource assignment field can be referred to as a frequency resource indicator value (FRIV). The frequency resource assignment field indicates the number of contiguously allocated sub-channels for each of the N actual resources and the starting sub-channel indexes of the N actual resources except the first resource. Here, the number of contiguously allocated sub-channels can be denoted by L_{subCH} where the L_{subCH}≥1. In the frequency domain, each resource among the N actual resources includes the L_{subCH} sub-channel(s). The starting sub-channel indexes for the first resource among the N actual resources can be denoted as

$${n}_{subCH , 0}^{start}$$

where the sub-channel with index

$${n}_{subCH , 0}^{start}$$

is a sub-channel on which the lowest PRB of the associated PSCCH is transmitted. Moreover, the sub-channel with index

$${n}_{subCH , 0}^{start}$$

is also a lowest sub-channel for the sidelink (PSSCH) transmission scheduled by the SCI format 1-A.

Additionally,

$${n}_{subCH , 1}^{start}$$

denotes the starting sub-channel index for the second resource, and

$${n}_{subCH , 2}^{start}$$

denotes the starting sub-channel index for the third resource.

In mode 1, after determining the frequency resource for PSSCH transmission for a UE, the base station may generate the frequency resource assignment (i.e., a FRIV) field in the DCI format 3_0 to indicate the UE the determined frequency resource for PSSCH transmission. The UE (i.e., a TX UE) may transmit a SCI format 1-A including the frequency resource assignment generated by the base station and transmit the PSCCH/PSSCH on the determined frequency resource. On the other hand, in mode 2, after determining the frequency resource for PSSCH transmission, the TX UE may generate the frequency resource assignment (i.e., a FRIV) field in the SCI format 1-A to indicate the determined frequency resource.

Upon detection the SCI format 1-A, a RX UE can determine the frequency resource based on the frequency resource assignment field. The frequency resource for PSSCH transmission herein may include the above-mentioned L_{subCH} sub-channel(s), the

$${n}_{subCH , 1}^{start} ,$$

and/or the

$${n}_{subCH , 2}^{start} .$$

To be specific, the frequency resource for PSSCH transmission can be determined from the FRIV as follows. If the sl-MaxNumPerReserve is 2, then

$$FRIV = {n}_{subCH , 1}^{start} + {\sum }_{i = 1}^{{L}_{subCH} - 1} ( {N}_{subchannel}^{SL} + 1 - i ) .$$

If the sl-MaxNumPerReserve is 3, then

$$FRIV = {n}_{subCH , 1}^{start} + {n}_{subCH , 2}^{start} \cdot ( {N}_{subchannel}^{SL} + 1 - {L}_{subCH} ) + {\sum }_{i = 1}^{{L}_{subCH} - 1} {( {N}_{subchannel}^{SL} + 1 - i )}^{2}$$

According to the above formulas for FRIV, the size of the frequency resource assignment is determined depending on a value indicated by the parameter sl-MaxNumPerReserve and another value indicated by the parameter sl-NumSubchannel.

For a sidelink transmission over the unlicensed spectrum, whether the sidelink transmission needs to meet the OCB requirements is depending on the area regulation and/or the band regulation. Therefore, for the sidelink transmission over the unlicensed spectrum, there is the possibility for a resource pool to be configured with either the existing transmission scheme or the interlaced transmission scheme. New determination for the size of frequency resource assignment is necessary and beneficial to adapt to the sidelink transmission over the unlicensed spectrum. The present disclosure provides new methods and solutions on determining the size of the frequency resource assignment for a resource pool, which would provide a more efficient and flexible sidelink communication system over unlicensed spectrum.

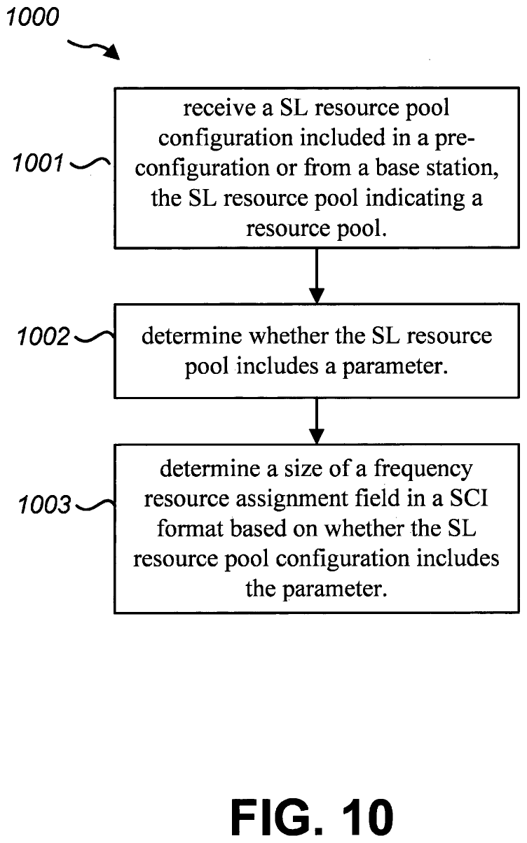

FIG. 10 is a flow diagram illustrating one implementation of a method 1000 for size determination of frequency resource assignment field by a UE 102. In the implementation of the present disclosure, how to determine the size of the frequency resource assignment field for a resource pool according to the resource pool configuration is illustrated hereinafter. The resource pool may be configured with the interlaced transmission scheme by the above-mentioned parameter A. Additionally or alternatively, the resource pool may be configured with the existing transmission scheme by the above-mentioned parameter A.

In 1001, the UE 102 (e.g., the reception unit of the UE 102) may receive a sidelink (SL) resource pool configuration wherein the SL resource pool configuration may be included in a pre-configuration or the SL resource pool configuration may be received by the UE 102 from the base station 160. To be specific, a memory unit of the UE 102 may store the pre-configuration in advance. A reception unit of the UE 102 may receive the SL resource pool configuration stored in the pre-configuration. Additionally, the reception unit of the UE 102 may receive the SL resource pool configuration from the base station 160. The memory unit of the UE 102 may store the SL resource pool configuration received from the base station 160 as well. The base station 160 may generate, to the UE 102, a SL resource pool configuration indicating a SL resource pool in a SL BWP and transmit the SL resource pool configuration to the UE 102.

The SL resource pool configuration may be included in a SL BWP configuration. A SL BWP configuration may include one or more SL resource pool configurations. Each SL resource pool configuration may indicate a resource pool in a SL BWP provided by the SL BWP configuration to the UE 102. The resource pool may be a resource pool which is used by the UE 102 for transmission of PSCCH, PSSCH and/or PSFCH. Additionally or alternatively, the resource pool may be a resource pool which is used by the UE 102 for reception of PSCCH, PSSCH and/or PSFCH.

The UE 102 (e.g., the control unit of the UE 102) may determine 1002 whether the SL resource pool configuration includes a parameter S or not. The base station 160 may determine whether to generate the parameter S in the SL resource pool configuration or not. In the present disclosure, a description ‘a SL resource pool configuration includes a parameter’ may also imply ‘a SL resource pool is (pre-)configured with a parameter’ or may also imply ‘a UE is configured with a parameter in a SL resource pool’. Likewise, a description ‘a SL resource pool configuration does not include a parameter’ may also imply ‘a SL resource pool is not (pre-)configured with a parameter’ or may also imply ‘a UE is not configured with a parameter in a SL resource pool’.

Determining whether the SL resource pool configuration includes a parameter S or not may include (I) determining whether a parameter S is present or absent in the resource pool configuration, and/or (II) determining which value the parameter S is set to, if the parameter S is present.

In the implementation, the parameter S may be related to whether the interlaced transmission is applied or enabled to the resource pool. In other words, the parameter S may be related to whether the existing transmission scheme is not applied or is disabled to the resource pool. Additionally or alternatively, the parameter S may include two values each of which may be indicted by the parameter S such that the parameter S can indicate, to a UE, which of the existing transmission scheme and the interlaced transmission scheme is applied to the resource pool. In other words, the parameter S herein may refer to the above-mentioned parameter A.

If the parameter S is present (i.e., the parameter S is included in the resource pool configuration or is generated by the base station 160 in the resource pool configuration), the UE may use interlaced transmission for sidelink transmission (e.g., the PSSCH transmission) in the resource pool. Additionally or alternatively, if the parameter S is present and the parameter S indicates the interlaced transmission is applied to the resource pool, the UE may use interlaced transmission for sidelink transmission in the resource pool. For the resource pool configured with the interlaced transmission scheme, a PSSCH transmission/reception is performed in one or more allocated sub-channels in the frequency domain where each sub-channel consists of one or more interlaces in the frequency domain and the indexes of the one or more allocated sub-channels can be contiguous or non-contiguous. Moreover, the RBs of the one or more interlaces included in a sub-channel may be non-contiguous in the frequency domain unless a sub-channel includes all the M interlaces in the frequency domain in an RB set. In other words, if the parameter is present, the UE 102 and/or the base station 160 may use interlace-based frequency domain resource allocation type for the sidelink transmission (e.g., the PSSCH transmission). The interlace-based frequency domain resource allocation type may imply that the frequency resource assignment may indicate a set of up to M interlace indexes and a set of RB sets for PSSCH transmission. The UE 102 configured with the parameter S may enable the interlaced PSSCH transmission/reception in the resource pool. That is, in the resource pool, the transmission and/or the reception of the PSCCH, the PSSCH and/or the PSFCH may be performed by the UE 102 in the interlaced basis.

If the parameter S is absent (i.e., the parameter S is not included in the resource pool configuration or is not generated by the base station 160 in the resource pool configuration), the UE may not use interlaced transmission for sidelink transmission (e.g., the PSSCH transmission) in the resource pool and the UE may use the existing transmission scheme for sidelink transmission in the resource pool (i.e., PSSCH transmission/reception is performed on one or more sub-channels where each sub-channel includes contiguous RBs in the frequency domain). Additionally or alternatively, if the parameter S is present and the parameter S indicates the existing transmission scheme is applied to the resource pool, the UE 102 may use the existing transmission scheme for sidelink transmission in the resource pool. For the resource pool configured with the existing transmission scheme, a PSSCH transmission/reception is performed in one or more contiguously allocated sub-channels in the frequency domain where each sub-channel consists of one or more contiguous RBs in the frequency domain. In other words, if the parameter is absent, the UE may use the frequency resource assignment field to indicate one or multiple starting sub-channel indexes and a number of contiguously allocated sub-channels. The UE not configured with the parameter S can not enable the interlaced PSSCH transmission/reception in the resource pool.

Additionally or alternatively, the parameter S may be a parameter related to indicate whether a sub-channel in the resource pool consists of one or more interlaces or consists of one or more contiguous RBs in the frequency domain. The RBs of the one or more interlaces may be contiguous or non-contiguous in the frequency domain.

Additionally or alternatively, the parameter S may refer to the above-mentioned parameter B. That is, the parameter S may be a parameter to indicate a starting interlace index for a resource pool. More specifically, the parameter S may be a parameter to indicate a starting interlace index for a sub-channel within a lowest index within a resource pool.

Additionally or alternatively, the parameter S may refer to the above-mentioned parameter C. That is, the parameter S may be a parameter to indicate a number of interlaces, K, where the K interlaces are included in a sub-channel in a resource pool.

The UE 102 (e.g., the control unit of the UE 102) may determine 1003 a size of a frequency resource assignment field in a SCI format (e.g., the SCI format 1-A) based on whether the SL resource pool configuration includes the parameter S. The base station 160 may determine a size of a frequency resource assignment field in the DCI format 3-0 based on whether the SL resource pool configuration includes the parameter S.

In a case that the resource pool configuration does not include the parameter S, the UE 102 and/or the base station 160 may use a method A to determine the size of the frequency resource assignment field in the resource pool. In a case that the resource pool configuration includes the parameter S, the UE 102 and/or the base station may use a method B to determine the size of the frequency resource assignment field in the resource pool. The determination of using the method A or the method B by the UE 102 and/or the base station 160 to calculate the size of the frequency resource assignment field for a resource pool is based on whether the resource pool configuration includes the parameter S or not.

Additionally or alternative, in a case that the resource pool configuration includes the parameter S and the parameter S is set to a first value (the exist transmission scheme), the UE 102 and/or the base station 160 may use a method A to determine the size of the frequency resource assignment field in the resource pool. In a case that the resource pool configuration includes the parameter S and the parameter S is set to a second value (the interlaced transmission scheme), the UE 102 and/or the base station may use a method B to determine the size of the frequency resource assignment field in the resource pool. The determination of using the method A or the method B by the UE 102 and/or the base station 160 to calculate the size of the frequency resource assignment field for a resource pool is based on whether the resource pool configuration includes the parameter S or not and/or which value the parameter S is set to.

The method A here refers to the existing determination for the size of the frequency resource assignment field. That is, as above-mentioned, the method A includes determining the size of the frequency resource assignment field based on the parameter sl-MaxNumPerReserve and the parameter sl-NumSubchannel. More specifically, in the case that the resource pool configuration does not include the parameter S (i.e., the resource pool is not configured with interlaced transmission), the UE 102 and/or the base station 160 may determine the size of the frequency resource assignment field based on a value indicated by the parameter sl-MaxNumPerReserve and a value indicated by the parameter sl-NumSubchannel. The size of the frequency resource assignment field may be determined not based on the SCS of the SL BWP which includes the resource pool.

The method B may include a method B1 and a method B2. The UE 102 may execute one of the method B1 and the method B2. A parameter included in the resource pool configuration may indicate to the UE 102 which one of the method B1 and the method B2 is executed for the resource pool. Additionally or alternatively, the UE 102 may be configured with one of the method B1 and the method B2 in advance. Additionally or alternatively, in the present disclosure, the UE 102 may be required to execute either of the method B1 and the method B2.

In an example of the method B1, the method B1 is a method including determining the size of the frequency resource assignment based on one, more or all of a number of interlaces M which is depending on the SCS of the SL BWP including the resource pool, a value indicated by the parameter C, a number of RB sets included in the resource pool. The frequency resource assignment field is used to allocate the frequency domain resource for PSSCH transmission in the resource pool in the SL BWP. The size of the frequency resource assignment field according to the method B1 may be determined based on the SCS of the SL BWP which includes the resource pool. Different from the method A, the UE may not use the parameter sl-NumSubchannel to determine the size of the frequency resource assignment field.

In the example of the method B1, the frequency resource assignment field may at least include two parts, e.g., one part with X bit(s) providing the interlace allocation, and the other part with Y bit(s) providing the RB set allocation. Herein, the X bits may provide the interlace allocation for a resource for a PSSCH transmission or reception.

In the example of the method B1, as in 1001, the UE 102 may receive a SL resource pool configuration indicating a SL resource pool in a SL BWP. The base station 160 may transmit, to the UE 102, the SL resource pool configuration indicating the SL resource pool in the SL BWP. The SL resource pool herein may be configured with interlaced transmission. And the SL BWP herein may be configured with SCS=15 kHz. The resource pool may include a first number of one or more RB sets in the frequency domain and the SL BWP may include a second number of one or more RB sets in the frequency domain. The first number may be equal to or less than the second number. The UE 102 and/or the base station 160 may determine Y bit(s) of the frequency resource assignment field based on the first number. To be specific, the UE 102 and/or the base station 160 may determine the value of Y as

$$⌈ {log}_{2} ( \frac{{N}_{RB - set}^{SL} ( {N}_{RB - set}^{SL} + 1 )}{2} ) ⌉ .$$

### The

$${N}_{RB - set}^{SL}$$

is the first number which is the number of RB sets included in the resource pool.

Furthermore, the UE 102 and/or the base station 160 may determine the value of the X bit(s) based on one, more or all of a number of interlaces M which is depending on the SCS of the SL BWP including the resource pool, a value indicated by the parameter C, a number of RB sets included in the resource pool. The value of X bit(s) may be associated with the number of one or more sub-channel included in the resource pool. In other words, the UE 102 and/or the base station 160 may determine or calculate the value of X bit(s) based on a determined number of the one or more sub-channels included in the resource pool. The UE 102 and/or the base station 160 may determine a number of one or more sub-channels included in the resource pool based on a number of interlace M, the parameter C. As above-mentioned, the parameter C indicates a number of interlaces, K, where the K interlaces are included in a sub-channel in the resource pool. The detailed determination of the number of one or more sub-channels N_{subch} are described above according to the second concept of the sub-channel.

In the example of the method B1, in a case A that the determined number of the one or more sub-channels, N_{subch}, is equal to a first value, the value of X bit(s) (i.e., a number of bits of the frequency resource assignment field providing interlace allocation in a slot) is equal to a predefined value A. The first value may be a value larger than 5. For example, the first value may be 10. The predefined value A may be a value equal to 6. Additionally or alternatively, in a case that the determined number of the one or more sub-channels is equal to the first value, the value of X bit(s) is determined as

$$⌈ {log}_{2} ( \frac{{N}_{subch} ( {N}_{subch} + 1 )}{2} ) ⌉$$

In the case A, the X bit(s) indicates a resource indication value (RIV). A RIV corresponds to a starting sub-channel index s₀ and a number of contiguous sub-channel indexes L where the RIV (0<=RIV<M(M+1)/2) is defined by:

```
if (L − 1) <= ┌M/2┐ then
    RIV = M (L − 1) + s₀
else
  RIV = M (M − L − 1) + (M − 1 − s₀).
```

The X bit(s) indicates to a UE a set of allocated sub-channel indexes s₀+l where l=0, 1, . . . , L−1. Actually, given a sub-channel consists of the K interlaces, the RIV can also indicate to a UE, a set of one or more allocated interlace indexes. For RIV>=M(M+1)/2, each RIV can indicate a predefined set of interlaces with non-contiguous interlace indexes.

In a case B that the determined number of the one or more sub-channels, N_{subch}, is less than the first value but is larger than a second value, the number of the one or more bits providing interlace allocation is equal to the determined number of the one or more sub-channels. The second value may be a value which is equal to 1. That is, in the case B, the value of X bit(s) is determined as N_{subch}. The X bit(s) comprise a bitmap indicating the sub-channels that are allocated for PSSCH. The sub-channel bitmap is of size X bits with one bitmap bit per sub-channel. The order of sub-channel bitmap is such that sub-channel 0 to sub-channel N_{subch}−1 are mapped from MSB to LSB of the sub-channel bitmap. If a bit value in the bitmap is 1, a sub-channel corresponding to the bit is allocated to the UE for a PSSCH transmission. If a bit value in the bitmap is 0, a sub-channel corresponding to the bit is not allocated to the UE for a PSSCH transmission. For example, if the bitmap with X=2 bits is indicated as ‘01’, the sub-channel with index 1 is allocated to the UE for PSSCH transmission and the sub-channel with index 0 is not allocated to the UE for PSSCH transmission.

In a case C that the determined number of the one or more sub-channels, N_{subch}, is equal to the second value, the value of X bit(s) is equal to 0. It implies that the UE may always use all the frequency resources of the resource pool for a PSSCH transmission in a slot.

In the example of the method B1, different from the method A, the UE 102 according to the method B1 may not use the parameter sl-NumSubchannel to determine the size of the frequency resource assignment field.

In an example of the method B2, the method B2 is a method including determining the size of the frequency resource assignment based on one, more or all of a number of interlaces M which is depending on the SCS of the SL BWP including the resource pool, a value indicated by the parameter C, a number of RB sets included in the resource pool, a value indicated by the parameter sl-MaxNumPerReserve. The size of the frequency resource assignment field according to the method B1 may be determined based on the SCS of the SL BWP which includes the resource pool. Different from the method A, the UE may not use the parameter sl-NumSubchannel to determine the size of the frequency resource assignment field.

In the example of the method B2, the frequency resource assignment fields may have Z bit(s). The Z bit(s) may provide the sub-channel allocation for PSSCH transmission or reception. The value of Z bit(s) may be associated with the number of one or more sub-channel included in the resource pool. In other words, the UE 102 may determine or calculate the value of Z bit(s) based on a determined number of the one or more sub-channels included in the resource pool. The UE may determine a number of one or more sub-channels included in the resource pool at least based on a number of interlace M, the parameter C, and the number of RB sets included in the resource pool. As above-mentioned, the parameter C indicates a number of interlaces, K, where the K interlaces are included in a sub-channel in the resource pool. The detailed determination of the number of one or more sub-channels N_{subch} are described above according to the first concept of the sub-channel. Like for the method B1, given the sub-channel consists of the K interlaces, the frequency resource assignment field can also indicate to a UE 102, a set of one or more allocated interlace indexes.

In the example of method B2, when the value of the parameter sl-MaxNumPerReserve is configured to 2, the UE 102 may determine the value of Z bit(s) as

$$⌈ {log}_{2} ( \frac{{N}_{subch} ( {N}_{subch} + 1 )}{2} ) ⌉ .$$

When the value of the parameter sl-MaxNumPerReserve is configured to 3, the UE 102 may determine the value of Z bit(s) as

$$⌈ {log}_{2} ( \frac{{N}_{subch} ( {N}_{subch} + 1 ) ( 2 {N}_{subch} + 1 )}{6} ) ⌉ .$$

The Z bit(s) indicates a FRIV which can indicate, as above-mentioned, a number of contiguously allocated sub-channels and one or more starting sub-channel indexes. However, different from the method A, the UE 102 according to the method B2 may not use the parameter sl-NumSubchannel to determine the size of the frequency resource assignment field.

According to the provided methods, the UE 102 can determine the size of frequency resource assignment field included the SCI format 1-A in a resource pool for the sidelink communication over unlicensed spectrum. According to the provided methods, the base station 160 can determine the size of frequency resource assignment field included the DCI format 3-0 to indicate to a UE the allocated frequency resource in a resource pool for the UE to perform the sidelink communication over unlicensed spectrum.

A TX UE and/or the base station 160 may determine the size of the frequency resource assignment field and determine the frequency resource allocated for a PSSCH transmission, and then generate the frequency resource assignment field with the determined size in the SCI format 1-A to indicate the allocated frequency resource to RX UE(s) for the PSSCH transmission. The TX UE may transmit the PSCCH with the SCI format 1-A and the PSSCH in the allocated resource scheduled by the SCI format 1-A.

Likewise, prior to detect a PSCCH from a TX UE, the RX may need to determine the size of the frequency resource assignment field and determine the size of the SCI format 1-A for PSCCH reception. Upon the successful detection of the PSCCH with the SCI format 1-A, the RX UE may derive the SCI format 1-A. The RX UE may identify the frequency resource assignment field with the determined to determine the allocated frequency resource for the PSSCH reception.

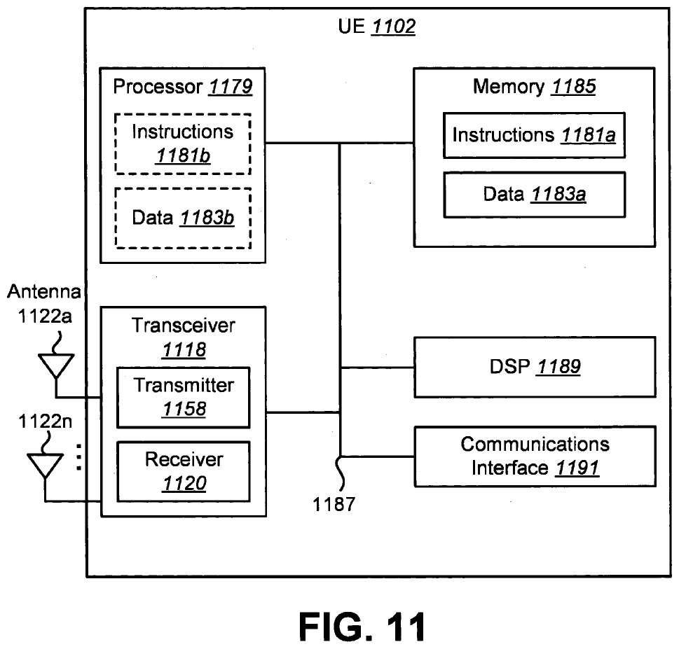

FIG. 11 illustrates various components that may be utilized in a UE 1102. The UE 1102 (UE 102) described in connection with FIG. 11 may be implemented in accordance with the UE 102 described in connection with FIG. 1. The UE 1102 includes a processor 1181 that controls operation of the UE 1102. The processor 1181 may also be referred to as a central processing unit (CPU). Memory 1187, which may include read-only memory (ROM), random access memory (RAM), a combination of the two or any type of device that may store information, provides instructions 1183a and data 1185a to the processor 1181. A portion of the memory 1187 may also include non-volatile random access memory (NVRAM). Instructions 1183b and data 1185b may also reside in the processor 1181. Instructions 1183b and/or data 1185b loaded into the processor 1181 may also include instructions 1183a and/or data 1185a from memory 1187 that were loaded for execution or processing by the processor 1181. The instructions 1183b may be executed by the processor 1181 to implement one or more of the methods described above.

The UE 1102 may also include a housing that contains one or more transmitters 1158 and one or more receivers 1120 to allow transmission and reception of data. The transmitter(s) 1158 and receiver(s) 1120 may be combined into one or more transceivers 1118. One or more antennas 1122a-n are attached to the housing and electrically coupled to the transceiver 1118.

The various components of the UE 1102 are coupled together by a bus system 1189, which may include a power bus, a control signal bus and a status signal bus, in addition to a data bus. However, for the sake of clarity, the various buses are illustrated in FIG. 11 as the bus system 1189. The UE 1102 may also include a digital signal processor (DSP) 1191 for use in processing signals. The UE 1102 may also include a communications interface 1193 that provides user access to the functions of the UE 1102. The UE 1102 illustrated in FIG. 11 is a functional block diagram rather than a listing of specific components.

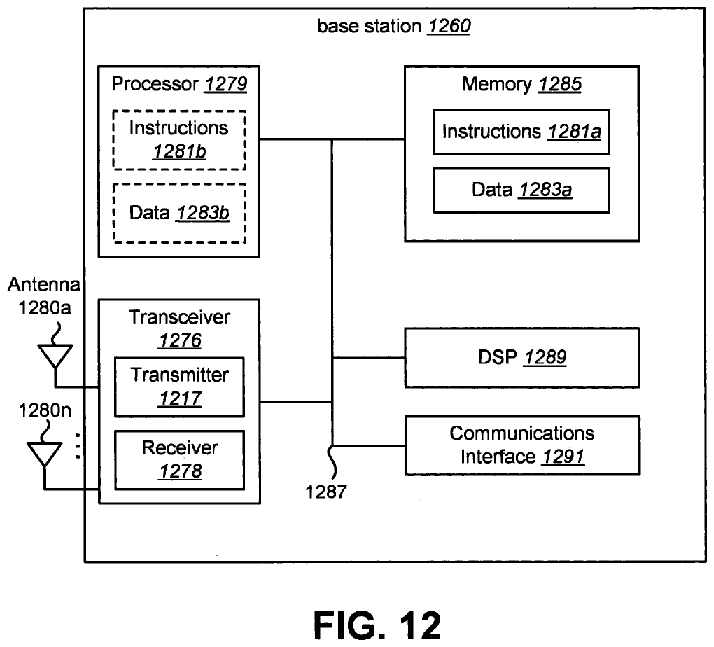

FIG. 12 illustrates various components that may be utilized in a base station 1260. The base station 1260 described in connection with FIG. 12 may be implemented in accordance with the base station 160 described in connection with FIG. 1. The base station 1260 includes a processor 1281 that controls operation of the base station 1260. The processor 1281 may also be referred to as a central processing unit (CPU). Memory 1287, which may include read-only memory (ROM), random access memory (RAM), a combination of the two or any type of device that may store information, provides instructions 1283a and data 1285a to the processor 1281. A portion of the memory 1287 may also include non-volatile random access memory (NVRAM). Instructions 1283b and data 1285b may also reside in the processor 1281. Instructions 1283b and/or data 1285b loaded into the processor 1281 may also include instructions 1283a and/or data 1285a from memory 1287 that were loaded for execution or processing by the processor 1281. The instructions 1283b may be executed by the processor 1281 to implement one or more of the methods 300 described above.

The base station 1260 may also include a housing that contains one or more transmitters 1217 and one or more receivers 1278 to allow transmission and reception of data. The transmitter(s) 1217 and receiver(s) 1278 may be combined into one or more transceivers 1276. One or more antennas 1280a-n are attached to the housing and electrically coupled to the transceiver 1276.

The various components of the base station 1260 are coupled together by a bus system 1289, which may include a power bus, a control signal bus and a status signal bus, in addition to a data bus. However, for the sake of clarity, the various buses are illustrated in FIG. 12 as the bus system 1289. The base station 1260 may also include a digital signal processor (DSP) 1291 for use in processing signals. The base station 1260 may also include a communications interface 1293 that provides user access to the functions of the base station 1260. The base station 1260 illustrated in FIG. 12 is a functional block diagram rather than a listing of specific components.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using circuitry, a chipset, an application-specific integrated circuit (ASIC), a large-scale integrated circuit (LSD or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods and apparatus described herein without departing from the scope of the claims.

1. A user equipment (UE), comprising:
reception circuitry configured to receive a sidelink (SL) resource pool configuration, the SL resource pool configuration indicating a SL resource pool in a SL bandwidth part (BWP), the SL resource pool including a first number of one or more resource block (RB), sets; and
control circuitry configured to determine a second number of one or more sub-channels at least based on a third number of interlaces and a first parameter, the first parameter indicating a fourth number of interlaces to be included in a sub-channel, and
to determine a size of a frequency resource assignment field in a SCI format as (X+Y) bits, wherein X bits providing sub-channel allocation for a PSSCH, Y bits providing RB set allocation for the PSSCH, a value of the X is determined based on the determined second number, and a value of the Y is determined based on the first number.

2. The UE according to the claim 1: wherein
the size of the frequency resource assignment field is determined as (X+Y) bits in the case that a second parameter is received and the second parameter is set to a first value to indicate interlaced transmission is applied in the SL resource pool.

3. The UE according to the claim 1: wherein
in a case that subcarrier spacing of the SL BWP is 15 kHz, the third number of interlaces is 10, and
in a case that the subcarrier spacing of the SL BWP is 30 Khz, the third number of interlaces is 5.

4. A communication method performed by a user equipment (UE), comprising:
receiving a sidelink (SL) resource pool configuration, the SL resource pool configuration indicating a SL resource pool in a SL bandwidth part (BWP), the SL resource pool including a first number of one or more resource block (RB) sets;
determining a second number of one or more sub-channels at least based on a third number of interlaces and a first parameter, the first parameter indicating a fourth number of interlaces to be included in a sub-channel; and
determining a size of a frequency resource assignment field in a SCI format as (X+Y) bits, wherein X bits providing sub-channel allocation for a PSSCH, Y bits providing RB set allocation for the PSSCH, a value of the X is determined based on the determined second number, and a value of the Y is determined based on the first number.

5. Abase station, comprising:
transmission circuitry configured to transmit, to a user equipment (UE), a sidelink (SL) resource pool configuration, the SL resource pool configuration indicating a SL resource pool in a SL bandwidth part (BWP), the SL resource pool including a first number of one or more resource block (RB) sets; and
control circuitry configured to determine a second number of one or more sub-channels at least based on a third number of interlaces and a first parameter, the first parameter indicating a fourth number of interlaces to be included in a sub-channel, and
to determine a size of a frequency resource assignment field in a SCI format as (X+Y) bits, wherein X bits providing sub-channel allocation for a PSSCH, Y bits providing RB set allocation for the PSSCH, wherein a value of the X is determined based on the determined second number, and a value of the Y is determined based on the first number.

6. The base station according to the claim 5: wherein
the size of the frequency resource assignment field is determined as (X+Y) bits in the case that a second parameter is transmitted to the UE and the second parameter is set to a first value to indicate interlaced transmission is applied in the SL resource pool.

7. The base station according to the claim 5: wherein
in a case that subcarrier spacing of the SL BWP is 15 kHz, the third number of interlaces is 10, and
in a case that the subcarrier spacing of the SL BWP is 30 Khz, the third number of interlaces is 5.
